(19) United States
(12) Patent Application Publication
(10) Pub. No.: US 2012/0327649 A1
(43) Pub. Date: Dec. 27, 2012

(54) LED BASED ILLUMINATION MODULE WITH A LENS ELEMENT

(75) Inventors: Gerard Harbers, Sunnyvale, CA (US); Serge J.A. Bierhuizen, San Jose, CA (US)

(73) Assignee: Xicato, Inc., San Jose, CA (US)

(21) Appl. No.: 13/527,446

(22) Filed: Jun. 19, 2012

Related U.S. Application Data
(60) Provisional application No. 61/500,924, filed on Jun. 24, 2011.
(60) Provisional application No. 61/566,993, filed on Dec. 5, 2011.

(51) Int. Cl. F21V 13/02; F21V 5/04

(52) U.S. Cl. 362/230; 362/235

(57) ABSTRACT

An illumination module includes a plurality of Light Emitting Diodes (LEDs). The illumination module includes a reflective mask cover plate disposed over the LEDs. The reflective mask includes a patterned reflective layer with an opening area aligned with the active die area of the LEDs. The reflective mask may be a patterned reflective layer disposed between the plurality of LEDs and a lens element, wherein a void in the patterned reflective layer is filled with a material that mechanically and optically couples the plurality of LEDs and the lens element. The illumination module may include a color conversion cavity that envelopes a lens element that may include a dichroic filter. The lens element may have different surface profiles over different groups of LEDs.

### CROSS REFERENCE TO RELATED APPLICATIONS

This application claims priority under 35 USC 119 to U.S. Provisional Application No. 61/500,924, filed Jun. 24, 2011, and U.S. Provisional Application No. 61/566,993, filed Dec. 5, 2011, both of which are incorporated by reference herein in their entireties.

### TECHNICAL FIELD

The described embodiments relate to illumination modules that include Light Emitting Diodes (LEDs).

### BACKGROUND

The use of light emitting diodes in general lighting is still limited due to limitations in light output level or flux generated by the illumination devices. Illumination devices that use LEDs also typically suffer from poor color quality characterized by color point instability. The color point instability varies over time as well as from part to part. Poor color quality is also characterized by poor color rendering, which is due to the spectrum produced by the LED light sources having bands with no or little power. Further, illumination devices that use LEDs typically have spatial and/or angular variations in the color. Additionally, illumination devices that use LEDs are expensive due to, among other things, the necessity of required color control electronics and/or sensors to maintain the color point of the light source or using only a small selection of produced LEDs that meet the color and/or flux requirements for the application.

Consequently, improvements to illumination device that uses light emitting diodes as the light source are desired.

### SUMMARY

An illumination module includes a plurality of Light Emitting Diodes (LEDs). The illumination module includes a reflective mask cover plate disposed over the LEDs. The reflective mask includes a patterned reflective layer with an opening area aligned with the active die area of the LEDs. The reflective mask may be a patterned reflective layer disposed between the plurality of LEDs and a lens element, wherein a void in the patterned reflective layer is filled with a material that mechanically and optically couples the plurality of LEDs and the lens element. The illumination module may include a color conversion cavity that envelopes a lens element that may include a dichroic filter. The lens element may have different surface profiles over different groups of LEDs.

Further details and embodiments and techniques are described in the detailed description below. This summary does not define the invention. The invention is defined by the claims.

### BRIEF DESCRIPTION OF THE DRAWINGS

FIGS. 1, 2, and 3 illustrate three exemplary luminaires, including an illumination device, reflector, and light fixture.

FIG. 4 shows an exploded view illustrating components of LED based illumination device as depicted in FIG. 1.

FIGS. 5A and 5B illustrates a perspective, cross-sectional view of LED based illumination device as depicted in FIG. 1.

FIG. 6 and FIG. 7 are illustrative of a cross-sectional and top view, respectively, of LED based illumination module that includes a reflective mask cover plate.

FIG. 8 is illustrative of a cross-section of LED based illumination module in one embodiment.

FIGS. 9A and 9B illustrate flexible, optically translucent material located on the surface of transmissive layer of the reflective mask cover plate shown above and in contact with LED mounting board, respectively.

FIGS. 10A and 10B illustrate optically translucent material separating patterned reflective layer from a transmissive layer of the reflective mask cover plate shown above and in contact with the LED mounting board, respectively.

FIG. 11 is illustrative of a cross-section of LED based illumination module similar to that depicted in FIGS. 6 and 7.

FIG. 12 illustrates the emission of both unconverted light and color converted light into a color conversion cavity of the illumination module.

FIG. 13 illustrates a single wavelength converting material applied over the entire surface area of the transmissive layer to enhance color conversion of back reflected light.

FIG. 14 illustrates wavelength converting materials applied in a pattern over portions of transmissive layer.

FIG. 15 illustrates multiple, stacked transmissive layers with different wavelength converting materials.

FIG. 16 illustrates wavelength converting materials uniformly applied as a pattern of droplets to the surface of transmissive layer.

FIG. 17 illustrates droplets of wavelength converting material spaced on the transmissive layer in a non-uniform pattern.

FIG. 18 illustrates, droplets of different wavelength converting materials placed in different locations of the transmissive layer placed in a non-uniform pattern.

FIG. 19 illustrates a cross-sectional view of portions of a reflective structure disposed on the transmissive layer.

FIG. 20 illustrates a cross-sectional view of LED based illumination module similar to that depicted in FIG. 19 with another transmissive layer disposed on the reflective structure.

FIGS. 21 and 22 illustrate an LED based illumination module with an interspatial reflective element fixed in position with respect to the LEDs with overmolded len(s).

FIG. 23 illustrates a cross-sectional, side view of an LED based illumination module with an interspatial reflector and overmolded lens within a color conversion cavity.

FIG. 24 illustrates a cross-sectional, side view of an LED based illumination module similar to FIG. 23, but with the interspatial reflector including shaped surfaces to promote light extraction from LEDs.

FIG. 25 illustrates a cross-sectional, side view of an LED based illumination module similar to FIG. 23, but with the overmolded lens shaped differently over different LEDs.

FIG. 26 illustrates a cross-sectional, side view of an LED based illumination module with a patterned reflective layer attached to a lens element and located between the lens element and LEDs.

FIG. 27 illustrates a cross-sectional, side view of an LED based illumination module similar to FIG. 26, but the outward facing surface of the lens element includes a dichroic coating.

FIG. 28 illustrates a cross-sectional, side view of an LED based illumination module with a lens element that includes two different surface profiles joined on the outward facing surface of lens element.

FIG. 29 illustrates a cross-sectional, side view of an LED based illumination module with a portion of a sidewall oriented at an oblique angle with respect to mounting board.

FIG. 30 illustrates a cross-sectional, side view of an LED based illumination module with a shaped lens element physically and optically coupled to the LEDs and optically coupled to the sidewall of the color conversion cavity.

FIG. 31 illustrates a cross-sectional, side view of an LED based illumination module with shaped lens elements physically and optically coupled to the LEDs and output window and optically coupled to the sidewall of the color conversion cavity.

### DETAILED DESCRIPTION

Reference will now be made in detail to background examples and some embodiments of the invention, examples of which are illustrated in the accompanying drawings.

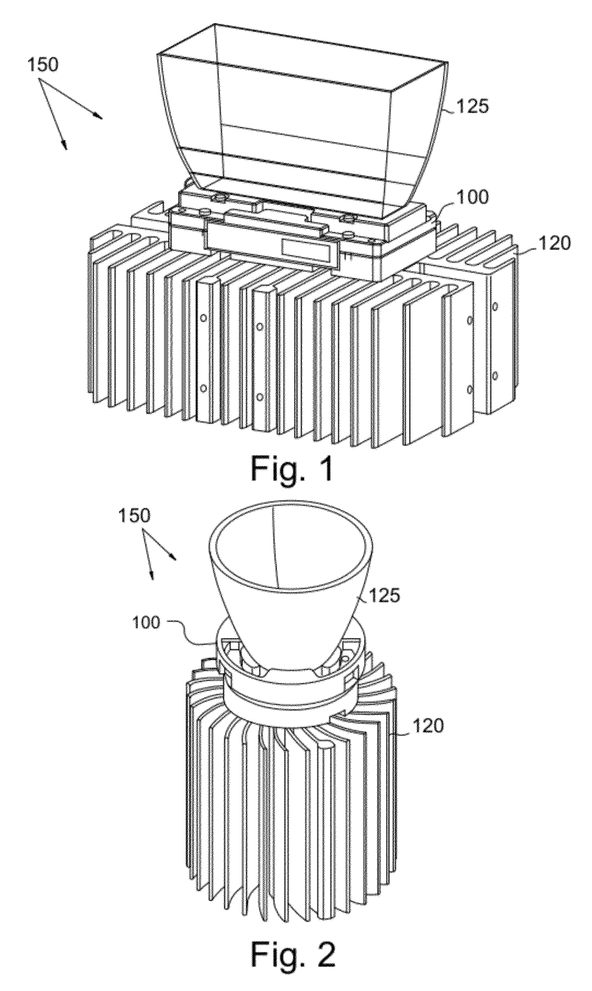

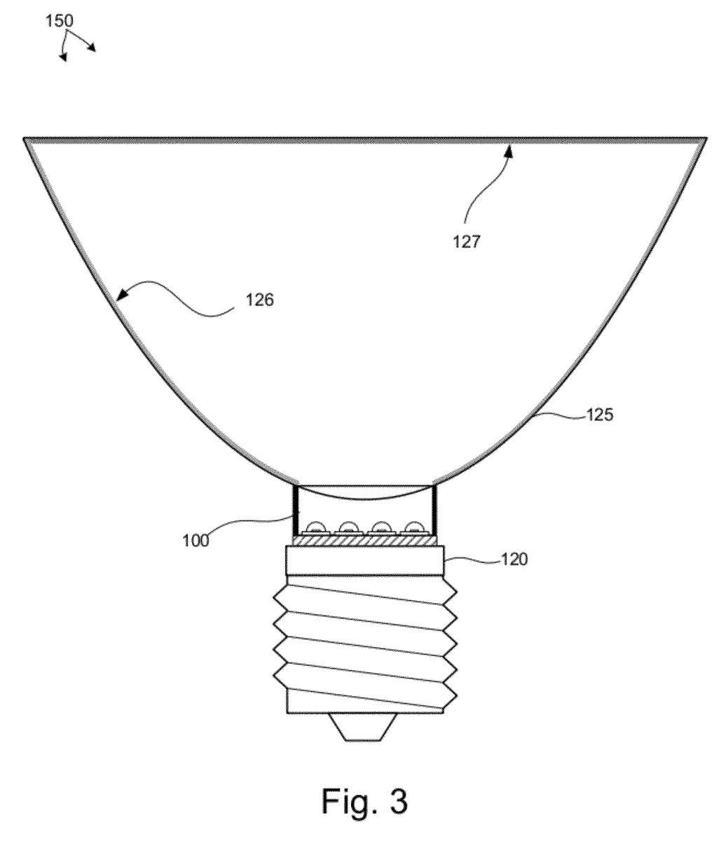

FIGS. 1, 2, and 3 illustrate three exemplary luminaires, all labeled 150. The luminaire illustrated in FIG. 1 includes an illumination module 100 with a rectangular form factor. The luminaire illustrated in FIG. 2 includes an illumination module 100 with a circular form factor. The luminaire illustrated in FIG. 3 includes an illumination module 100 integrated into a retrofit lamp device. These examples are for illustrative purposes. Examples of illumination modules of general polygonal and elliptical shapes may also be contemplated. Luminaire 150 includes illumination module 100, reflector 125, and light fixture 120. As depicted, light fixture 120 includes a heat sink capability, and therefore may be sometimes referred to as heat sink 120. However, light fixture 120 may include other structural and decorative elements (not shown). Reflector 125 is mounted to illumination module 100 to collimate or deflect light emitted from illumination module 100. The reflector 125 may be made from a thermally conductive material, such as a material that includes aluminum or copper and may be thermally coupled to illumination module 100. Heat flows by conduction through illumination module 100 and the thermally conductive reflector 125. Heat also flows via thermal convection over the reflector 125. Reflector 125 may be a compound parabolic concentrator, where the concentrator is constructed of or coated with a highly reflecting material. Optical elements, such as a diffuser or reflector 125 may be removably coupled to illumination module 100, e.g., by means of threads, a clamp, a twist-lock mechanism, or other appropriate arrangement. As illustrated in FIG. 3, the reflector 125 may include sidewalls 126 and a window 127 that are optionally coated, e.g., with a wavelength converting material, diffusing material or any other desired material.

As depicted in FIGS. 1, 2, and 3, illumination module 100 is mounted to heat sink 120. Heat sink 120 may be made from a thermally conductive material, such as a material that includes aluminum or copper and may be thermally coupled to illumination module 100. Heat flows by conduction through illumination module 100 and the thermally conductive heat sink 120. Heat also flows via thermal convection over heat sink 120. Illumination module 100 may be attached to heat sink 120 by way of screw threads to clamp the illumination module 100 to the heat sink 120. To facilitate easy removal and replacement of illumination module 100, illumination module 100 may be removably coupled to heat sink 120, e.g., by means of a clamp mechanism, a twist-lock mechanism, or other appropriate arrangement. Illumination module 100 includes at least one thermally conductive surface that is thermally coupled to heat sink 120, e.g., directly or using thermal grease, thermal tape, thermal pads, or thermal epoxy. For adequate cooling of the LEDs, a thermal contact area of at least 50 square millimeters, but preferably 100 square millimeters should be used per one watt of electrical energy flow into the LEDs on the board. For example, in the case when 20 LEDs are used, a 1000 to 2000 square millimeter heat sink contact area should be used. Using a larger heat sink 120 may permit the LEDs 102 to be driven at higher power, and also allows for different heat sink designs. For example, some designs may exhibit a cooling capacity that is less dependent on the orientation of the heat sink. In addition, fans or other solutions for forced cooling may be used to remove the heat from the device. The bottom heat sink may include an aperture so that electrical connections can be made to the illumination module 100.

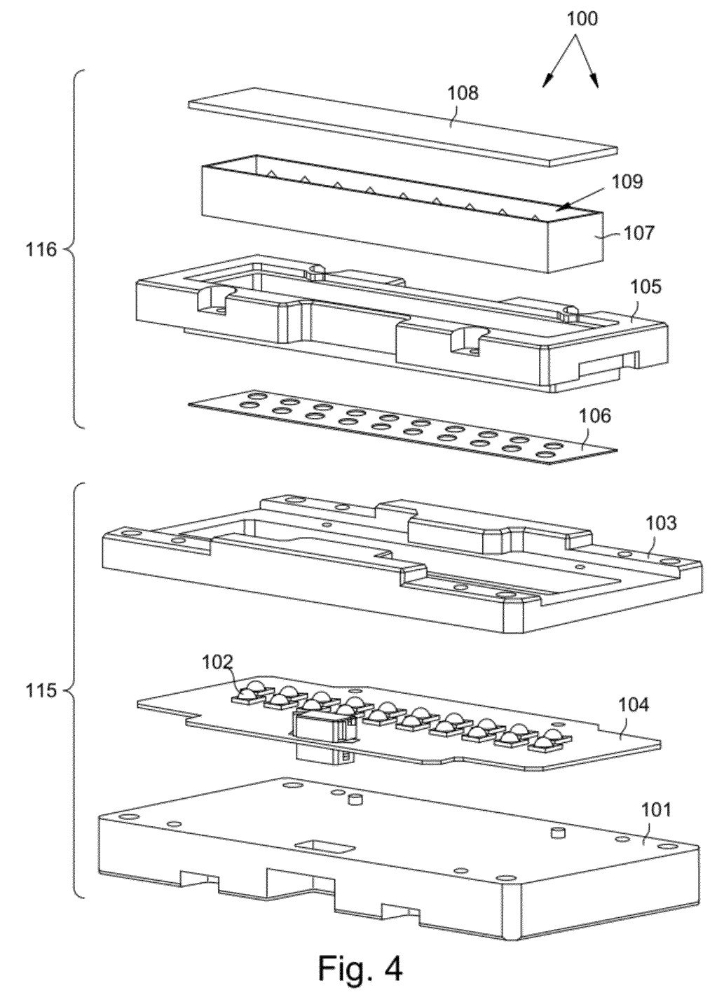

FIG. 4 illustrates an exploded view of components of LED based illumination module 100 as depicted in FIG. 1 by way of example. It should be understood that as defined herein an LED based illumination module is not an LED, but is an LED light source or fixture or component part of an LED light source or fixture. For example, an LED based illumination module may be an LED based replacement lamp such as depicted in FIG. 3. LED based illumination module 100 includes one or more LED die or packaged LEDs and a mounting board to which LED die or packaged LEDs are attached. In one embodiment, the LEDs 102 are packaged LEDs, such as the Luxeon Rebel manufactured by Philips Lumileds Lighting. Other types of packaged LEDs may also be used, such as those manufactured by OSRAM (Oslon package), Luminus Devices (USA), Cree (USA), Nichia (Japan), or Tridonic (Austria). As defined herein, a packaged LED is an assembly of one or more LED die that contains electrical connections, such as wire bond connections or stud bumps, and possibly includes an optical element and thermal, mechanical, and electrical interfaces. The LED chip typically has a size about 1 mm by 1 mm by 0.5 mm, but these dimensions may vary. In some embodiments, the LEDs 102 may include multiple chips. The multiple chips can emit light of similar or different colors, e.g., red, green, and blue. Mounting board 104 is attached to mounting base 101 and secured in position by mounting board retaining ring 103. Together, mounting board 104 populated by LEDs 102 and mounting board retaining ring 103 comprise light source sub-assembly 115. Light source sub-assembly 115 is operable to convert electrical energy into light using LEDs 102. The light emitted from light source sub-assembly 115 is directed to light conversion sub-assembly 116 for color mixing and color conversion. Light conversion sub-assembly 116 includes cavity body 105 and an output port, which is illustrated as, but is not limited to, an output window 108. Light conversion sub-assembly 116 optionally includes either or both bottom reflector insert 106 and sidewall insert 107. Output window 108, if used as the output port, is fixed to the top of cavity body 105. In some embodiments, output window 108 may be fixed to cavity body 105 by an adhesive. To promote heat dissipation from the output window to cavity body 105, a thermally conductive adhesive is desirable. The adhesive should reliably withstand the temperature present at the interface of the output window 108 and cavity body 105. Furthermore, it is preferable that the adhesive either reflect or transmit as much incident light as possible, rather than absorbing light emitted from output window 108. In one example, the combination of heat tolerance, thermal conductivity, and optical properties of one of several adhesives manufactured by Dow Corning (USA) (e.g., Dow Corning model number SE4420, SE4422, SE4486, 1-4173, or SE9210), provides suitable performance. However, other thermally conductive adhesives may also be considered.

Either the interior sidewalls of cavity body 105 or sidewall insert 107, when optionally placed inside cavity body 105, is reflective so that light from LEDs 102, as well as any wavelength converted light, is reflected within the cavity 160 until it is transmitted through the output port, e.g., output window 108 when mounted over light source sub-assembly 115. Bottom reflector insert 106 may optionally be placed over mounting board 104. Bottom reflector insert 106 includes holes such that the light emitting portion of each LED 102 is not blocked by bottom reflector insert 106. Sidewall insert 107 may optionally be placed inside cavity body 105 such that the interior surfaces of sidewall insert 107 direct light from the LEDs 102 to the output window when cavity body 105 is mounted over light source sub-assembly 115. Although as depicted, the interior sidewalls of cavity body 105 are rectangular in shape as viewed from the top of illumination module 100, other shapes may be contemplated (e.g., clover shaped or polygonal). In addition, the interior sidewalls of cavity body 105 may taper or curve outward from mounting board 104 to output window 108, rather than perpendicular to output window 108 as depicted.

Bottom reflector insert 106 and sidewall insert 107 may be highly reflective so that light reflecting downward in the cavity 160 is reflected back generally towards the output port, e.g., output window 108. Additionally, inserts 106 and 107 may have a high thermal conductivity, such that it acts as an additional heat spreader. By way of example, the inserts 106 and 107 may be made with a highly thermally conductive material, such as an aluminum based material that is processed to make the material highly reflective and durable. By way of example, a material referred to as Miro®, manufactured by Alanod, a German company, may be used. High reflectivity may be achieved by polishing the aluminum, or by covering the inside surface of inserts 106 and 107 with one or more reflective coatings. Inserts 106 and 107 might alternatively be made from a highly reflective thin material, such as Vikuiti™ ESR, as sold by 3M (USA), Lumirror™ E60L manufactured by Toray (Japan), or microcrystalline polyethylene terephthalate (MCPET) such as that manufactured by Furukawa Electric Co. Ltd. (Japan). In other examples, inserts 106 and 107 may be made from a polytetrafluoroethylene PTFE material. In some examples inserts 106 and 107 may be made from a PTFE material of one to two millimeters thick, as sold by W.L. Gore (USA) and Berghof (Germany). In yet other embodiments, inserts 106 and 107 may be constructed from a PTFE material backed by a thin reflective layer such as a metallic layer or a non-metallic layer such as ESR, E60L, or MCPET. Also, highly diffuse reflective coatings can be applied to any of sidewall insert 107, bottom reflector insert 106, output window 108, cavity body 105, and mounting board 104. Such coatings may include titanium dioxide (TiO2), zinc oxide (ZnO), and barium sulfate (BaSO4) particles, or a combination of these materials.

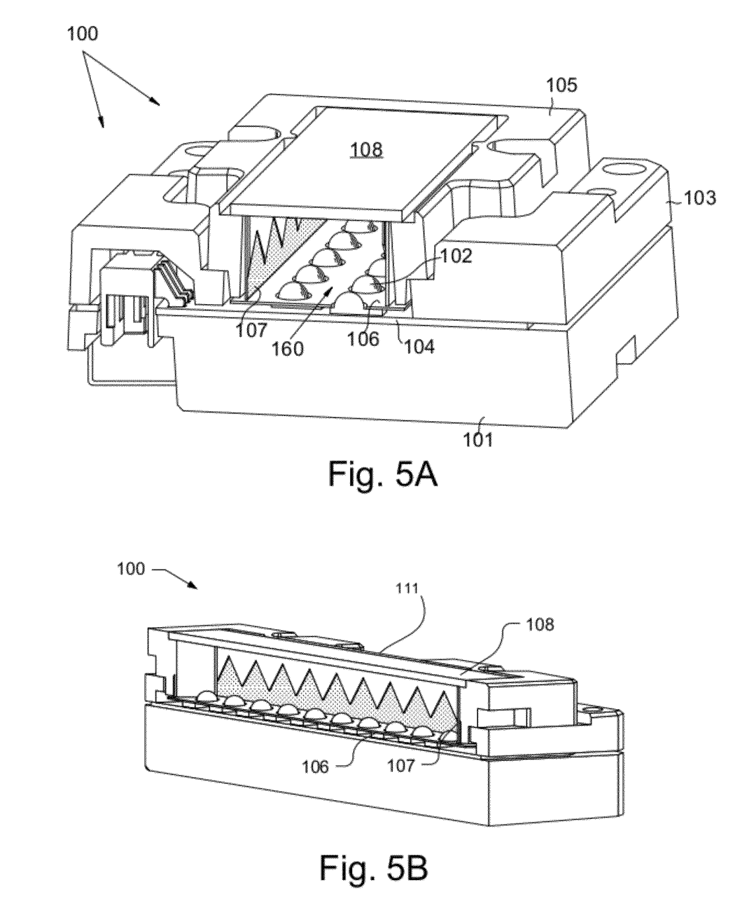

FIGS. 5A and 5B illustrate perspective, cross-sectional views of LED based illumination module 100 as depicted in FIG. 1. In this embodiment, the sidewall insert 107, output window 108, and bottom reflector insert 106 disposed on mounting board 104 define a color conversion cavity 160 (illustrated in FIG. 5A) in the LED based illumination module 100. A portion of light from the LEDs 102 is reflected within color conversion cavity 160 until it exits through output window 108. Reflecting the light within the cavity 160 prior to exiting the output window 108 has the effect of mixing the light and providing a more uniform distribution of the light that is emitted from the LED based illumination module 100. In addition, as light reflects within the cavity 160 prior to exiting the output window 108, an amount of light is color converted by interaction with a wavelength converting material included in the cavity 160. In some embodiments color conversion cavity 160 does not include wavelength converting material. In these embodiments, color conversion cavity 160 functions to mix light passing through color conversion cavity 160 without color conversion.

As depicted in FIGS. 1-5B, light generated by LEDs 102 is generally emitted into color conversion cavity 160. However, various embodiments are introduced herein to improve the light extraction efficiency from LED based illumination module 100. In one aspect a reflective mask cover plate 173 placed above the LEDs 102 includes a patterned reflective layer 175 that allows light emitted from LEDs 102 to pass through the reflective mask cover plate 173, but redirects back reflected light into the color conversion cavity 160. In this manner, back reflected light that might otherwise be absorbed in the spaces between and around the LEDs 102 is redirected toward the output of LED based illumination module 100. In another aspect, an interspatial reflector 195 redirects back reflected light into the color conversion cavity 160 and is fixed with respect to the LEDs 102 by an overmolded lens 184. The overmolded lens 184 constrains the interspatial reflector 195 and collimates the redirected light toward the output of LED based illumination module 100, thus improving extraction efficiency of color conversion cavity 160.

LEDs 102 can emit different or the same colors, either by direct emission or by phosphor conversion, e.g., where phosphor layers are applied to the LEDs as part of the LED package. The illumination device 100 may use any combination of colored LEDs 102, such as red, green, blue, amber, or cyan, or the LEDs 102 may all produce the same color light. Some or all of the LEDs 102 may produce white light. In addition, the LEDs 102 may emit polarized light or non-polarized light and LED based illumination device 100 may use any combination of polarized or non-polarized LEDs. In some embodiments, LEDs 102 emit either blue or UV light because of the efficiency of LEDs emitting in these wavelength ranges. The light emitted from the illumination device 100 has a desired color when LEDs 102 are used in combination with wavelength converting materials included in color conversion cavity 160. The photo converting properties of the wavelength converting materials in combination with the mixing of light within cavity 160 results in a color converted light output. By tuning the chemical and/or physical (such as thickness and concentration) properties of the wavelength converting materials and the geometric properties of the coatings on the interior surfaces of cavity 160, specific color properties of light output by output window 108 may be specified, e.g., color point, color temperature, and color rendering index (CRI).

For purposes of this patent document, a wavelength converting material is any single chemical compound or mixture of different chemical compounds that performs a color conversion function, e.g., absorbs an amount of light of one peak wavelength, and in response, emits an amount of light at another peak wavelength.

Portions of cavity 160, such as the bottom reflector insert 106, sidewall insert 107, cavity body 105, output window 108, and other components placed inside the cavity (not shown) may be coated with or include a wavelength converting material. FIG. 5B illustrates portions of the sidewall insert 107 coated with a wavelength converting material. Furthermore, different components of cavity 160 may be coated with the same or a different wavelength converting material.

By way of example, phosphors may be chosen from the set denoted by the following chemical formulas: Y3Al5O12:Ce, (also known as YAG:Ce, or simply YAG) (Y,Gd)3Al5O12:Ce, CaS:Eu, SrS:Eu, SrGa2S4:Eu, Ca3(Sc,Mg)2Si3O12:Ce, Ca3Sc2Si3O12:Ce, Ca3Sc2O4:Ce, Ba3Si6O12N2:Eu, (Sr,Ca)AlSiN3:Eu, CaAlSiN3:Eu, CaAlSi(ON)3:Eu, Ba2SiO4:Eu, Sr2SiO4:Eu, Ca2SiO4:Eu, CaSc2O4:Ce, CaSi2O2N2:Eu, SrSi2O2N2:Eu, BaSi2O2N2:Eu, Ca5(PO4)3Cl:Eu, Ba5(PO4)3Cl:Eu, Cs2CaP2O7, Cs2SrP2O7, Lu3Al5O12:Ce, Ca8Mg(SiO4)4Cl2:Eu, Sr8Mg(SiO4)4Cl2:Eu, La3Si6N11:Ce, Y3Ga5O12:Ce, Gd3Ga5O12:Ce, Tb3Al5O12:Ce, Tb3Ga5O12:Ce, and Lu3Ga5O12:Ce.

In one example, the adjustment of color point of the illumination device may be accomplished by replacing sidewall insert 107 and/or the output window 108, which similarly may be coated or impregnated with one or more wavelength converting materials. In one embodiment a red emitting phosphor such as a europium activated alkaline earth silicon nitride (e.g., (Sr,Ca)AlSiN3:Eu) covers a portion of sidewall insert 107 and bottom reflector insert 106 at the bottom of the cavity 160, and a YAG phosphor covers a portion of the output window 108. In another embodiment, a red emitting phosphor such as alkaline earth oxy silicon nitride covers a portion of sidewall insert 107 and bottom reflector insert 106 at the bottom of the cavity 160, and a blend of a red emitting alkaline earth oxy silicon nitride and a yellow emitting YAG phosphor covers a portion of the output window 108.

In some embodiments, the phosphors are mixed in a suitable solvent medium with a binder and, optionally, a surfactant and a plasticizer. The resulting mixture is deposited by any of spraying, screen printing, blade coating, or other suitable means. By choosing the shape and height of the sidewalls that define the cavity, and selecting which of the parts in the cavity will be covered with phosphor or not, and by optimization of the layer thickness and concentration of the phosphor layer on the surfaces of light mixing cavity 160, the color point of the light emitted from the module can be tuned as desired.

In one example, a single type of wavelength converting material may be patterned on the sidewall, which may be, e.g., the sidewall insert 107 shown in FIG. 5B. By way of example, a red phosphor may be patterned on different areas of the sidewall insert 107 and a yellow phosphor may cover the output window 108. The coverage and/or concentrations of the phosphors may be varied to produce different color temperatures. It should be understood that the coverage area of the red and/or the concentrations of the red and yellow phosphors will need to vary to produce the desired color temperatures if the light produced by the LEDs 102 varies. The color performance of the LEDs 102, red phosphor on the sidewall insert 107 and the yellow phosphor on the output window 108 may be measured before assembly and selected based on performance so that the assembled pieces produce the desired color temperature.

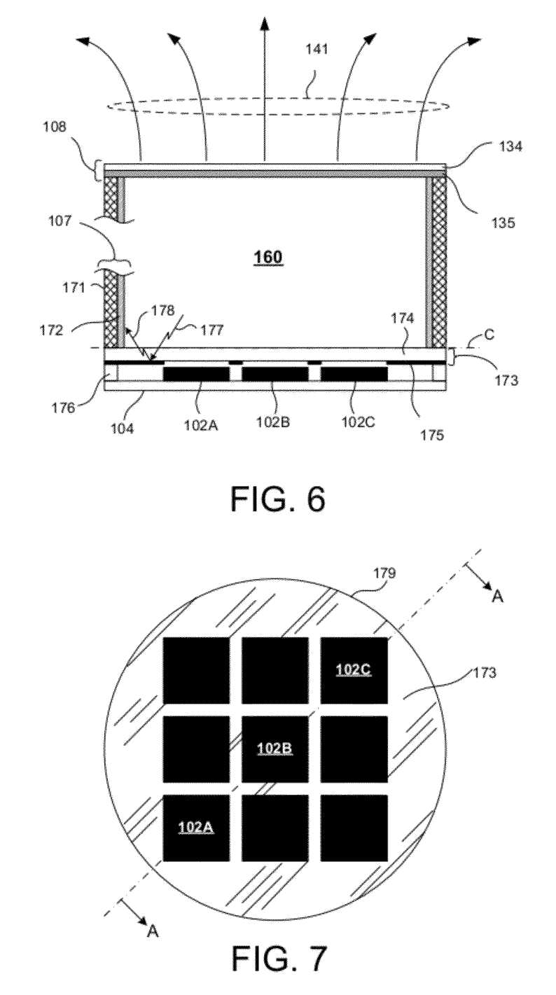

FIG. 6 is illustrative of a cross-sectional, side view of an LED based illumination module 100 in one embodiment, that is taken at section A depicted in FIG. 7. In the illustrated embodiment, LED based illumination module 100 includes a plurality of LEDs 102A-102C mounted to an LED mounting board 104, a sidewall 107, an output window 108, and a reflective mask cover plate 173. In the illustrated embodiment, sidewall 107 includes a reflective layer 171 and a color converting layer 172. Color converting layer 172 includes a wavelength converting material (e.g., a red-emitting phosphor material). In some embodiments, sidewall 107 does not include a color converting layer 172. In some embodiments, sidewall 107 is made from a material with high reflectivity. In the illustrated embodiment, output window 108 includes a transmissive layer 134 and a color converting layer 135. Color converting layer 135 includes a wavelength converting material with a different color conversion property than the wavelength converting material included in sidewall 107 (e.g., a yellow-emitting phosphor material). In some embodiments, output window 108 does not include a color converting layer. In some embodiments, output window 108 includes a diffusing layer or a transmissive layer made of translucent material.

Color conversion cavity 160 is bounded by sidewall 107, output window 108, and reflective mask cover plate 173 of LED based illumination module 100. Reflective mask cover plate 173 includes a transmissive layer 174 and a patterned reflective layer 175. In the illustrated embodiment, patterned reflective layer 175 is attached to transmissive layer 174. In one example, patterned reflective layer 175 is deposited onto transmissive layer 174 (e.g., metal layer deposition). In another example patterned reflective layer 175 is attached to transmissive layer 174 by adhesives. In yet another example, patterned reflective layer 175 is mechanically captured between transmissive layer 174 and LED mounting board 104. As depicted in FIG. 6, patterned reflective layer 175 lies between LEDs 102 and transmissive layer 174. However, in some embodiments, patterned reflective layer 175 lies on the opposite side of transmissive layer 174; away from LEDs 102. In these embodiments, transmissive layer 174 lies between LEDs 102 and patterned reflective layer 175. In some embodiments patterned reflective layer 175 may be captured between two transmissive layers 174. In some embodiments, patterned reflective layer 175 includes a suitably reflective material or combination of materials (e.g., silver, aluminum) plated on transmissive layer 174. In some other embodiments, patterned reflective layer 175 include a highly reflective material, such as sintered PTFE, Vikuiti™ ESR, as sold by 3M (USA), Lumirror™ E60L manufactured by Toray (Japan), or microcrystalline polyethylene terephthalate (MCPET) attached to transmissive layer 174. In some other embodiments, patterned reflective layer 175 includes reflective coatings applied to transmissive layer 174. Such coatings may include titanium dioxide (TiO2), zinc oxide (ZnO), and barium sulfate (BaSO4) particles patterned onto transmissive layer 174. Such coatings may also include polymer materials (e.g., silicones) loaded with reflective particles. The pattern of patterned reflective layer 175 is configured such that light emitted from LEDs 102 passes through the reflective mask cover plate 173 with a minimum of light blockage. However, patterned reflective layer 175 is configured so that back reflected light (light that is reflected back from color conversion cavity 160 toward mounting board 104 and LEDs 102) is redirected back into color conversion cavity 160. By including a patterned reflective layer 175 above the mounting board 104, light that might otherwise be absorbed by the mounting board is recycled. Thus, the light extraction efficiency of color conversion cavity 160 is improved.

Transmissive layers 134 and 174 may be constructed from a suitable optically transmissive material (e.g., sapphire, alumina, crown glass, polycarbonate, and other plastics).

As depicted in FIG. 6, reflective mask cover plate 173 is spaced above the light emitting surface of LEDs 102 by a clearance distance by standoff 176. In some embodiments, this is desirable to allow clearance for wire bond connections from the LED package submount to the active area of the LED. In some embodiments, a clearance of one millimeter or less is desirable to allow clearance for wire bond connections, but to avoid blocking an excessive amount of light emitted from the LEDs 102. In some other embodiments, a clearance of two hundred microns or less is desirable to avoid blocking an excessive amount of light emitted from the LEDs 102.

In some other embodiments, the clearance distance may be determined by the size of the LED 102. For example, the size of the LED 102 may be characterized by the length dimension of any side of a single, square shaped active die area. In some other examples, the size of the LED 102 may be characterized by the length dimension of any side of a rectangular shaped active die area. Some LEDs 102 include many active die areas (e.g., LED arrays). In these examples, the size of the LED 102 may be characterized by either the size of any individual die or by the size of the entire array. In some embodiments, the clearance should be less than the size of the LED 102 to avoid blocking an excessive amount of light emitted from LEDs 102. In some embodiments, the clearance should be less than twenty percent of the size of the LED 102. In some embodiments, the clearance should be less than five percent of the size of the LED. As the clearance is reduced, the amount of light blocked is reduced.

In some other embodiments, it is desirable to attach the reflective mask cover plate 173 directly to the surface of the LED 102. In this manner, the direct thermal contact between reflective mask cover plate 173 and LED 102 allows the reflective mask cover plate 173 to act as a heat dissipation mechanism to direct heat away from LEDs 102. In some other embodiments, the space between mounting board 104 and reflective mask cover plate 173 may be filled with a solid encapsulate material. By way of example, silicone may be used to fill the space. In some other embodiments, the space may be filled with a fluid to promote heat extraction from LEDs 102.

The light emitted from LEDs 102A-102C that passes through the reflective mask cover plate 173 enters color conversion cavity 160. Light is mixed within color conversion cavity 160. In embodiments that include color converting layers on any of the interior surfaces of color conversion cavity 160, light is color converted as discussed with reference to FIGS. 4 and 5A-5B. The resulting combined light 141 is emitted by LED based illumination module 100.

As depicted in FIG. 6, reflective mask cover plate 173 lies above a plane C defined by the light emitting surface of LEDs 102. Patterned reflective layer 175 is configured such that light emitted in a direction normal to plane C from any portion of the light emitting surface of each LED 102 is not blocked by layer 175. In addition, reflective mask cover plate 173 provides protection to the sensitive die area of LEDs 102 from contamination and mechanical abuse.

FIG. 7 is illustrative of a top view of a cross-section of LED based illumination module 100 taken at section C depicted in FIG. 6. As depicted, in this embodiment, LED based illumination module 100 is circular in shape as illustrated in the exemplary configuration depicted in FIG. 2. In this embodiment, LED based illumination module 100 has a circular aperture 179. Although, LED based illumination module 100 depicted in FIGS. 6 and 7 is circular in aperture, other shapes may be contemplated. For example, LED based illumination module 100 may be polygonal in shape. In other embodiments, LED based illumination module 100 may be configured in any other closed shape (e.g., elliptical, star-shaped, etc.). As depicted in FIG. 7, reflective mask cover plate 173 provides a number of transparent windows for light to pass from each of LEDs 102 into color conversion cavity 160. As viewed from the top, patterned reflective layer 175 presents a reflective surface over all the area of aperture 179 that is not windowed for light to pass. In this manner, as viewed from the top, an observer sees either the active die area of each of LEDs 102 or a highly reflective surface.

LED die are often square or rectangular in shape. However, many LED based illumination modules are configured with circular apertures to produce desirable illumination effects. The aperture area, i.e., area of the output window 108 is at least as large as the area of the active die areas of LEDs 102 combined with the reflective area of the reflective mask cover plate 173, (i.e., the area of patterned reflective layer 175). The geometric mismatch created by populating a round aperture with square or rectangular LED die leaves a significant amount of aperture area without active light emitting area. By covering as much of this area as possible with patterned reflective layer 175, absorption losses are minimized. Furthermore, in some embodiments, it is desirable to sparsely populate an aperture area with active light emitting area. Again, a significant amount of aperture area without active light emitting area is covered with patterned reflective layer 175 to minimize absorption losses.

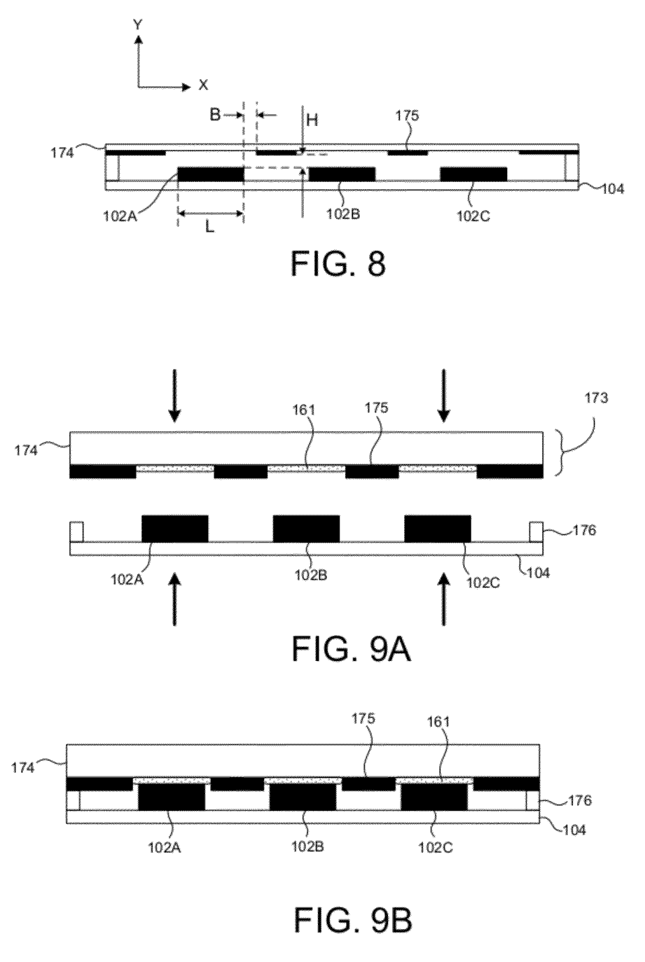

FIG. 8 is illustrative of a cross-section of LED based illumination module 100 in one embodiment. Light is emitted from an active light emitting area of each of LEDs 102. As illustrated in FIG. 8, one dimension of the active die area of LED 102A is characterized by a length, L. The edge of patterned reflective layer closest to LED 102A is located a distance, B, from the closest edge of LED 102A in the x-direction of the xy coordinate frame. Patterned reflective layer 175 is also located a distance, H, above (y-direction of xy coordinate frame) the light emitting area of LED 102A. The location and dimensions of patterned reflective layer 175 influence the blockage of light emitted over the entire active area of LEDs 102 and the amount of reflective area available to recycle light within color conversion cavity 160.

By reducing, dimension H, both the amount of light blockage is reduced and the amount of reflective area available for light recycling is increased. However, the selection of dimension B involves a trade-off between minimizing blockage of light emitted over the entire active area of LEDs 102 and maximizing the amount of reflective area available to recycle light within color conversion cavity 160.

Light is emitted at oblique angles with respect to the active surface area of LEDs 102. To minimize blockage of light emitted over the entire active area of LED 102A, blockage of light emitted from a portion of LED 102A closest to the patterned reflective layer and furthest from the patterned reflective layer may be considered. In one example, we determine that light emitted from the closest edge of LED 102A at any angle less than sixty degrees from normal (y-direction) should not be blocked. This can be expressed by constraint equation (1).

$${tan}^{- 1} ( \frac{H}{B} ) \leq 60 ° \qquad ( 1 )$$

In addition, we determine that light emitted from the furthest edge of LED 102A at any angle less than an eighty five degree angle from normal should not be blocked. This can be expressed by constraint equation (2).

$${tan}^{- 1} ( \frac{H}{L + B} ) \leq 85 ° \qquad ( 2 )$$

Given an active die area of LED 102A characterized by a length, L, and given a selection of dimension, H, the location and size for patterned reflective layer 175 may be determined based on the most restrictive of constraint equations (1) and (2). The angular constraint values illustrated in equations (1) and (2) are provided by way of example. Other angular values may be considered based on the angular distribution of light emitted from any particular LED 102. In general, as the angular values are increased, reduced light blockage is favored over increased light recycling. Conversely, as angular values are decreased, increased light recycling is favored over reduced light blockage. The angular values may be selected based on the angular distribution of light emitted from a particular LED 102. For example, if a large percentage of light emitted from a particular LED 102 is emitted within a cone angle of forty five degrees, it may be desirable to use angular values of at least forty five degrees for constraint equations (1) and (2). However, if a large percentage of light emitted from a particular LED 102 is emitted within a cone angle of sixty degrees, it may be desirable to use angular values of at least sixty degrees.

Constraint equations (1) and (2) are provided by way of example. Other design methodologies may be employed to determine the location and size of patterned reflective layer 175 based on the location of LEDs 102. For example, the location and size of patterned reflective layer 175 may be determined based on the gap between adjacent LEDs 102. In some other examples, the location and size of patterned reflective layer 175 may be determined based on the percentage of light emitted from LEDs 102 that is transmitted into color conversion cavity 160 through patterned reflective layer 174.

In the embodiment illustrated in FIGS. 9A-9B, patterned reflective layer 175 is located on the bottom side of transmissive layer 174 facing LEDs 102. As illustrated in FIG. 9A an amount of flexible, optically translucent material 161 is located on the surface of transmissive layer 174 in the voids of patterned reflective layer 175 aligned with LEDs 102. By way of non-limiting example, the flexible, optically translucent material 161 may include an adhesive, an optically clear silicone, a silicone loaded with reflective particles (e.g., titanium dioxide (TiO2), zinc oxide (ZnO), and barium sulfate (BaSO4) particles, or a combination of these materials), a silicone loaded with a wavelength converting material (e.g., phosphor particles), a sintered PTFE material, etc.

As illustrated in FIG. 9B, reflective mask cover plate 173 is brought into contact with LED mounting board 104 populated by LEDs 102 and is located with respect to LED mounting board 104 by standoff 176. The flexible, optically translucent material 161 effectively couples reflective mask cover plate 173 to LEDs 102. In some embodiments, flexible, optically translucent material 161 is cured to maintain a bond between LEDs 102 and reflective mask cover plate 173. In this manner, transmissive layer 174 is attached to the top surface of LEDs 102 and the patterned reflective layer 175 may completely close the gap between LEDs 102 within manufacturing tolerances.

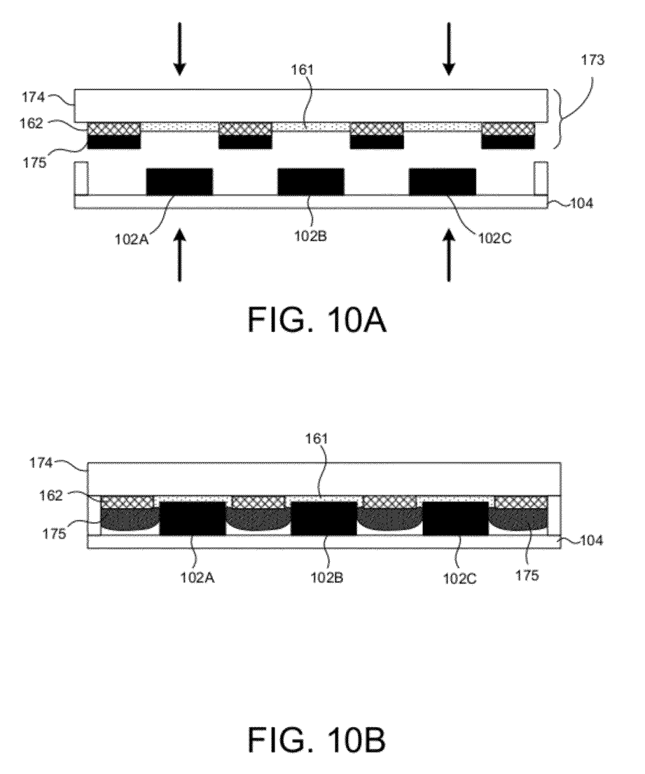

In another embodiment illustrated in FIGS. 10A-10B, patterned reflective layer 175 is located on the bottom side of transmissive layer 174 facing LEDs 102. An amount of flexible, optically translucent material 161 is located on the surface of transmissive layer 174 in the voids of patterned reflective layer 175 aligned with LEDs 102. However, as illustrated in FIG. 10A an amount of optically translucent material 162 separates patterned reflective layer 175 from transmissive layer 174. By way of non-limiting example, optically translucent material 162 may be constructed of silicone, glass, a polycarbonate material, sapphire, alumina, plastic, or other suitable material. In some embodiments, optically translucent material 162 is the same material as flexible, optically translucent material 161. It is desirable to select an optically translucent material 162 with an index of refraction that matches the index of refraction of transmissive layer 174 to promote light extraction. Separating patterned reflective layer 175 from transmissive layer 174 with optically translucent material 162 locates patterned reflective layer 175 below the top surface of LEDs 102 when transmissive layer 174 is bonded directly to LEDs 102. This allows large angle light emission from LEDs 102 to escape through optically translucent material 162 without being blocked by patterned reflective layer 175.

In some embodiments, patterned reflective layer 175 is constructed from a polymer based material that expands when cured. As illustrated in FIG. 10A, patterned reflective layer 175 is applied in an uncured or partially cured state. After locating reflective mask cover plate 173 onto LED mounting board 104, patterned reflective layer 175 is fully cured and expands to span between the LEDs 102. In this manner, space can be allowed between patterned reflective layer 175 and LEDs 102 during assembly to accommodate manufacturing tolerances. But these spaces are closed after assembly by expansion of the polymer based material. This effectively eliminates light traps that may be created by spaces between LEDs 102 and patterned reflective layer 175 after assembly.

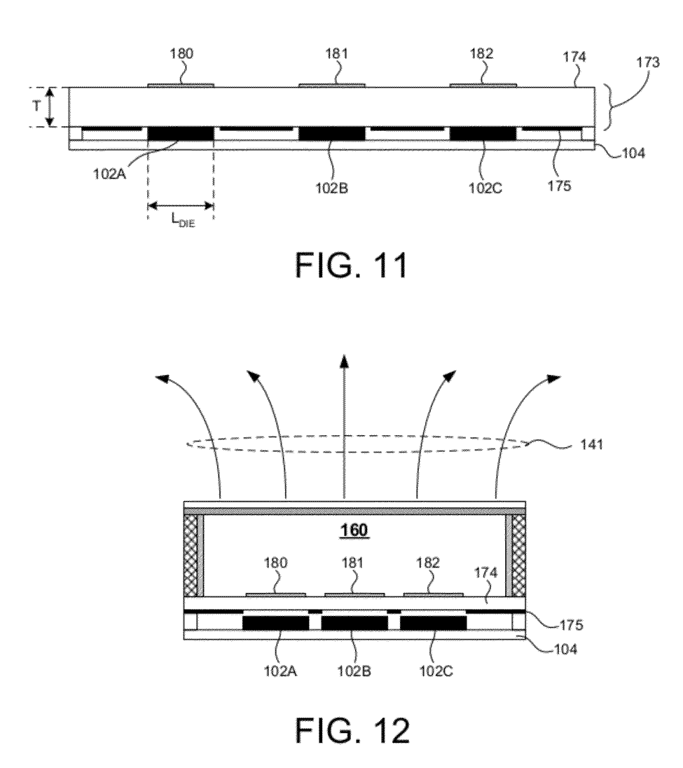

FIG. 11 is illustrative of a cross-section of LED based illumination module 100 similar to that depicted in FIGS. 6 and 7. In some embodiments, portions of reflective mask cover plate 173 include one or more wavelength converting materials. In the depicted embodiment, reflective mask cover plate 173 includes patterned reflective layer 175 disposed on the side of transmissive layer 174 closest to LEDs 102. Wavelength converting materials 180-182 are disposed on the side of transmissive layer 174 that is furthest from LEDs 102. By way of example, wavelength converting material 180 is disposed over a portion of transmissive layer 174 that lies above the window in patterned reflective layer 175 that allows light emitted from LED 102A to enter color conversion cavity 160. In this manner, light emitted from LED 102A passes through the window in patterned reflective layer 175, through transmissive layer 174, and interacts with wavelength converting material 180. In some embodiments, some amount of light passes through wavelength converting material 180 without color conversion and some amount of light is absorbed by wavelength converting material 180. This interaction results in the emission of both unconverted light and color converted light into color conversion cavity 160 as illustrated in FIG. 12. Similarly, wavelength converting materials 181 and 182 are disposed over portions of transmissive layer 174 that lie above windows in patterned reflective layer 175 that allow light emitted from LEDs 102B and 102C, respectively, to enter color conversion cavity 160. Wavelength converting materials 180-182 may be the same material or different materials. By employing different materials, color converted light of different colors may be directed into color conversion cavity 160 to improve the color rendering index (CRI) of combined light 141 output by module 100.

In some embodiments, the thickness of transmissive layer 174, T, is at least one half of the length of the die, LDIE. By increasing the thickness of transmissive layer 174 to at least half of the die length, the probablility is increased that backscattered light emitted from the wavelength converting materials 180-182 is incident upon patterned reflective layer 175 rather than the LED die itself. Since the reflectivity of patterned reflective layer 175 is greater than the reflectivity of the surface of the LED die, extraction efficiency may be improved.

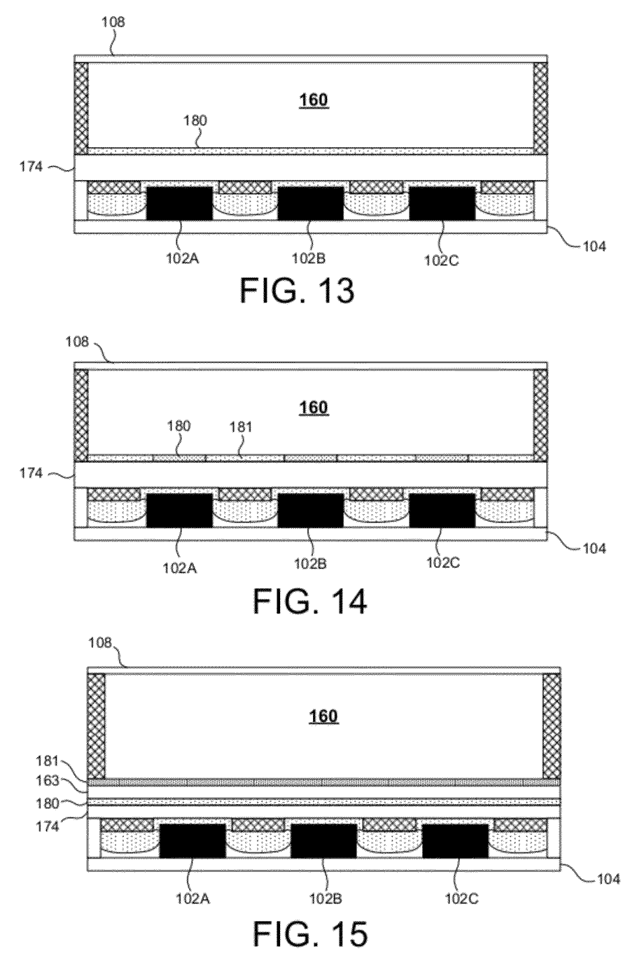

In some embodiments, a single wavelength converting material may be applied over the entire surface area of transmissive layer 174 to enhance color conversion of back reflected light and to simplify manufacture as illustrated in FIG. 13. However, in some embodiments, any of wavelength converting materials 180-182 may be applied in a pattern over portions of transmissive layer 174. In the embodiment illustrated in FIG. 14, wavelength converting material 180 is located over LEDs 102 and wavelength converting material 181 is located in areas between those including wavelength converting material 181.

In some embodiments, multiple, stacked transmissive layers are employed. Each transmissive layer includes different wavelength converting materials. For example, as illustrated in FIG. 15, transmissive layer 174 includes wavelength converting material 180 over the surface area of transmissive layer 174. In addition, a second transmissive layer 163 is placed over and in contact with transmissive layer 174. Transmissive layer 174 includes wavelength converting materisl 181. In this manner, the color point of light emitted from LED based illumination device 100 may be tuned by replacing transmissive layers 174 and 163 independently to achieve a desired color point. Although, as illustrated in FIG. 15, transmissive layer 163 is placed over and in contact with transmissive layer 174, a space may be maintained between the two elements. This may be desirable to promote cooling of the transmissive layers. For example, airflow may by introduced through the space to cool the transmissive layers.

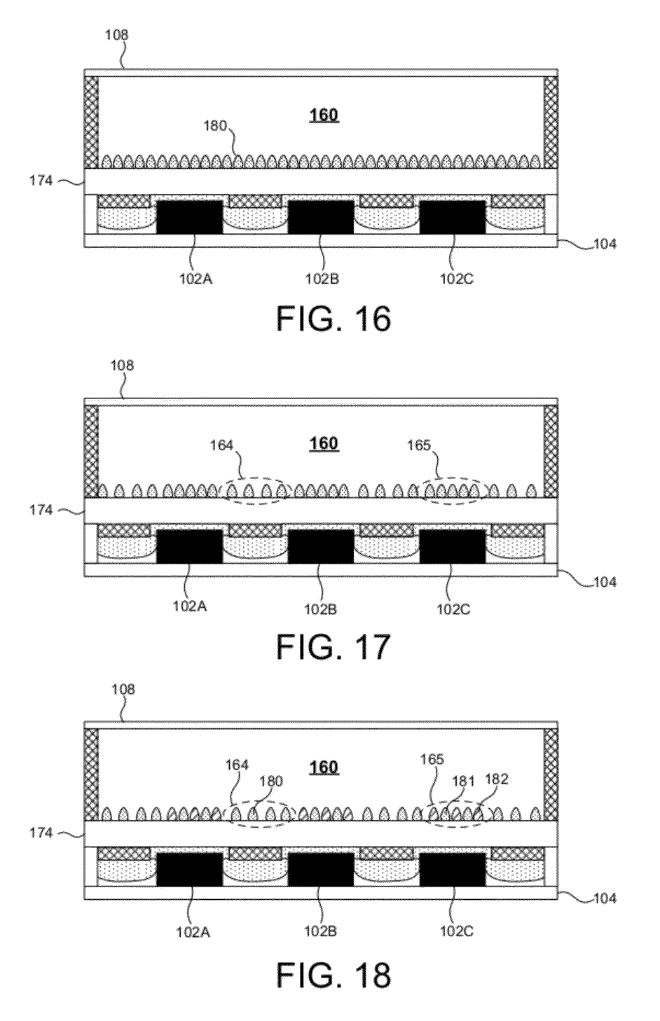

In some embodiments, any of the wavelength converting materials may be applied as a pattern (e.g., stripes, dots, blocks, droplets, etc.). For example, as illustrated in FIG. 16, droplets of wavelength converting material 180 are uniformly applied to the surface of transmissive layer 174. Shaped droplets may improve extraction efficiency by increasing the amount of surface area at the interface between the droplet and the material within color conversion cavity 160 (e.g., air, nitrogen, silicone, etc.).

As illustrated in FIG. 17, in some embodiments, droplets of wavelength converting material 180 may be spaced on transmissive layer 174 in a non-uniform pattern. For example, a group of droplets 165 located over LED 102C is densely packed (e.g., droplets in contact with adjacent droplets), while a group of droplets 164 located over a space between LEDs 102A and 102B is loosely packed (e.g., droplets spaced apart from adjacent droplets). In this manner, the color point of light emitted from LED based illumination module 100 may be tuned by varying the packing density of droplets on transmissive layer 174.

As illustrated in FIG. 18, in some embodiments, droplets of different wavelength converting materials may be placed in different locations of transmissive layer 174 and may also be placed in a non-uniform pattern. For example, group of droplets 164 may include wavelength converting material 180 and group of droplets 165 may include a combination of droplets including wavelength converting material 181 and wavelength converting material 182. In this manner, combinations of different wavelength converting materials are located relative to LEDs 102 in varying densities to achieve a desired color point of light emitted from LED based illumination module 100.

As depicted in FIGS. 11-18, wavelength converting materials are located on the surface of transmissive layer 174. However, in some other embodiments, any of the wavelength converting materials may be embedded within transmissive layer 174.

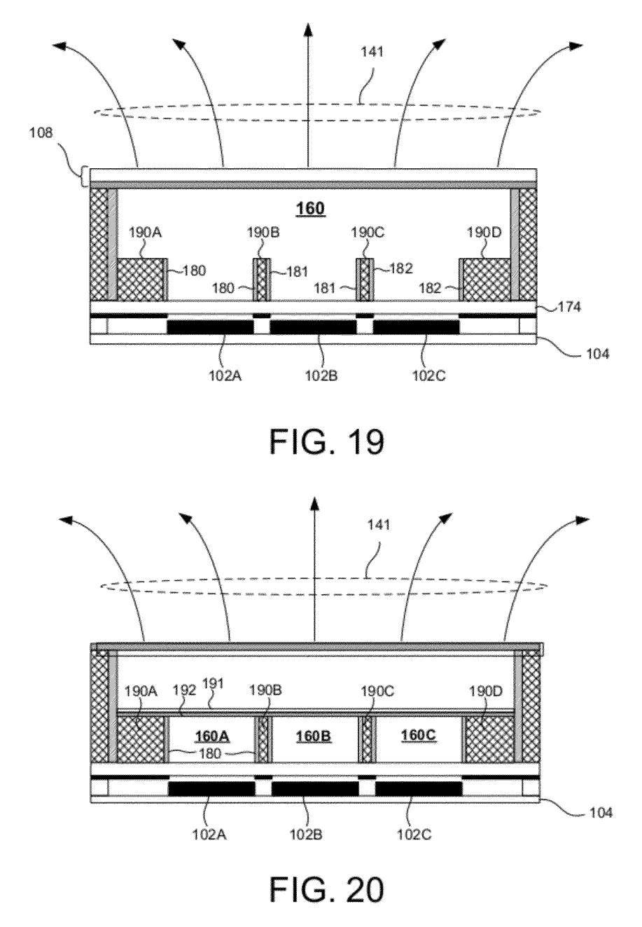

In one aspect, reflective mask cover plate 173 includes a reflective structure 190 that includes at least one wavelength converting material. FIG. 19 illustrates a cross-sectional view of portions 190A-190D of reflective structure 190. As illustrated in FIG. 19, reflective structure 190 is disposed on transmissive layer 174 and extends from the surface of transmissive layer 174 toward output window 108. Portions of reflective structure 190 include at least one wavelength converting material. In the embodiment depicted in FIG. 19, light emitted from LED 102A passes through a window in patterned reflective layer 175 and through transmissive layer 174 into color conversion cavity 160. Some amount of the emitted light interacts with wavelength converting material 180 disposed on portions 190A and 190B of reflective structure 190. The interaction results in color conversion of a portion of the light emitted from LED 102A as the light enters color conversion cavity 160. Similarly, portions of light emitted from LEDs 102B and 102C interact with wavelength converting materials 181 and 182, respectively. In this manner, different color light may be introduced into color conversion cavity 160 by the interaction of light emitted from LEDs 102 with reflective structure 190. In some embodiments, LEDs 102A-102C may be selected with emission properties that interact efficiently with the wavelength converting materials 180-182, respectively. For example, the emission spectrum of LED 102A and the wavelength converting material 180 may be selected such that the emission spectrum of LED 102A and the absorption spectrum of the wavelength converting material 180 are closely matched. In some embodiments, wavelength converting materials 180-182 may be the same material. In some embodiments, any of wavelength converting materials 180-182 may be applied in a continuous layer over portions of reflective structure 190. In some other embodiments, any of wavelength converting materials 180-182 may be applied as a pattern (e.g., stripes, dots, blocks, droplets, etc.). In some other embodiments, any of wavelength converting materials 180-182 may be embedded within reflective structure 190.

FIG. 20 illustrates a cross-sectional view of LED based illumination module 100 similar to that depicted in FIG. 19. As depicted, LED based illumination module 100 includes a transmissive layer 191 disposed on reflective structure 190. In this manner a number of color conversion cavities are formed within LED based illumination module 100. Each color conversion cavity (e.g., 160A, 160B, and 160C) is configured to color convert light emitted from each LED (e.g., 102A, 102B, 102C), respectively, before the light from each color conversion cavity (CCC) is combined. By altering any of the wavelength converting materials included in each CCC, the current supplied to any LED emitting into each CCC, and the shape of each CCC the color of light emitted from LED based illumination module 100 may be controlled and output beam uniformity improved.

As depicted in FIG. 20, LED 102A emits light directly into color conversion cavity 160A only. Similarly, LED 102B emits light directly into color conversion cavity 160B only, and LED 102C emits light directly into color conversion cavity 160C only. Each LED is isolated from the others by reflective structure 190.

Reflective structure 190 is highly reflective so that, for example, light emitted from a LED 102B is directed upward in color conversion cavity 160B generally towards the output window 108 of illumination module 100. Additionally, reflective structure 190 may have a high thermal conductivity, such that it acts as an additional heat spreader. By way of example, the reflective structure 190 may be made with a highly thermally conductive material, such as an aluminum based material that is processed to make the material highly reflective and durable. By way of example, a material referred to as Miro®, manufactured by Alanod, a German company, may be used. High reflectivity may be achieved by polishing the aluminum, or by covering the inside surface of reflective structure 190 with one or more reflective coatings. Reflective structure 190 might alternatively be made from a highly reflective thin material, such as Vikuiti™ ESR, as sold by 3M (USA), Lumirror™ E60L manufactured by Toray (Japan), or microcrystalline polyethylene terephthalate (MCPET) such as that manufactured by Furukawa Electric Co. Ltd. (Japan). In other examples, reflective structure 190 may be made from a PTFE material. In some examples reflective structure 190 may be made from a PTFE material of one to two millimeters thick, as sold by W.L. Gore (USA) and Berghof (Germany). In yet other embodiments, reflective structure may be constructed from a PTFE material backed by a thin reflective layer such as a metallic layer or a non-metallic layer such as ESR, E60L, or MCPET. Also, highly diffuse reflective coatings can be applied to reflective structure 190. Such coatings may include titanium dioxide (TiO2), zinc oxide (ZnO), and barium sulfate (BaSO4) particles, or a combination of these materials.

In one aspect LED based illumination module 100 includes a first color conversion cavity (e.g., 160A) formed from reflective structure 190 and transmissive layer 191. In some embodiments, the portions of reflective structure 190 that comprise color conversion cavity 160A include a first wavelength converting material 180 and a second wavelength converting material 192 coated on transmissive layer 191. In this manner, the color of light emitted from each color conversion cavity may be tuned by selecting the amount and type of wavelength converting materials included in each color conversion cavity. In one example, wavelength converting material 180 may include red emitting phosphor materials and wavelength converting material 192 includes yellow emitting phosphor materials. In some examples, each wavelength converting material included in color conversion cavities 160 and wavelength converting layer 192 is selected such that a color point of combined light 141 emitted from LED based illumination module 100 matches a target color point. In some other embodiments, each color conversion cavity (e.g., 160A-160C) may be filled with a solid encapsulate material. By way of example, silicone may be used to fill the space. In some other embodiments, the space may be filled with a fluid to promote heat extraction from LEDs 102.

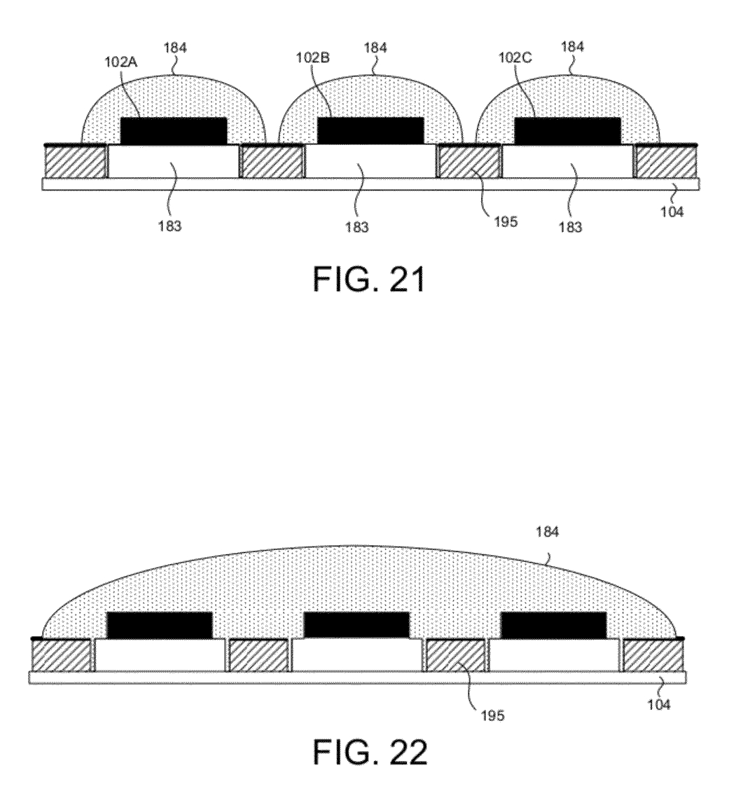

FIG. 21 is illustrative of LED based illumination module 100 in another embodiment. In one aspect, an interspatial reflective element 195 is a separate part disposed in the spaces between a number of LEDs 102 mounted on a mounting board 104, and the interspatial reflective element 195 is fixed in position with respect to the LEDs 102 by an overmolded lens structure 184. In the embodiment illustrated in FIG. 21, a raised pad 183 elevates each LED 102 above mounting board 104. In this manner a relatively thick interspatial reflective element 195 may be employed without protruding above the plane of the light emitting surface of each LED 102. In some other embodiments, raised pad 183 is not employed and each of LEDs 102 is mounted directly onto mounting board 104. In these embodiments, a relatively thin interspatial reflector (e.g., less than 100 microns thick) must be used to avoid protruding above the plane of the light emitting surface of each LED 102 and blocking light emitted from each LED 102.

As discussed above with respect to FIGS. 6 and 7, LED die are often square or rectangular in shape. However, many LED based illumination modules are configured with circular apertures to produce desirable illumination effects. The geometric mismatch created by populating a round aperture with square or rectangular LED die leaves a significant amount of aperture area without active light emitting area. By covering as much of this area as possible with interspatial reflector 195, absorption losses are minimized. Furthermore, in some embodiments, it is desirable to sparsely populate an aperture area with active light emitting area. Again, a significant amount of aperture area without active light emitting area is covered with interspatial reflector 195 to minimize absorption losses.

As depicted in FIGS. 21 and 22, overmolded lens 184 is formed over LEDs 102 and interspatial reflector 195 to fix the location of interspatial reflector 195 with respect to LEDs 102. Overmolded lens 184 provides protection for sensitive die area of LEDs 102. In addition the shape of overmolded lens 184 may be selected to promote light extraction from each LED 102. For example, overmolded lens 184 may be spherically shaped to maximize the escape angle for light emitted from each LED 102. Overmolded lens 184 may be constructed from material that is index matched to the die material of each LED 102 to maximize light extraction. In some embodiments, overmolded lens 184 is applied over packaged LEDs 102 that already include a lens structure. In these embodiments, the material of overmolded lens may be selected to index match that of the lens structure of the packaged LED 102 to minimize losses at the interface. In some embodiments, (e.g., the embodiment depicted in FIG. 12), overmolded lens 184 may be individually shaped over each LED 102. In some other embodiments, (e.g., the embodiment depicted in FIG. 22), overmolded lens 184 may be shaped over a group of LEDs 102.

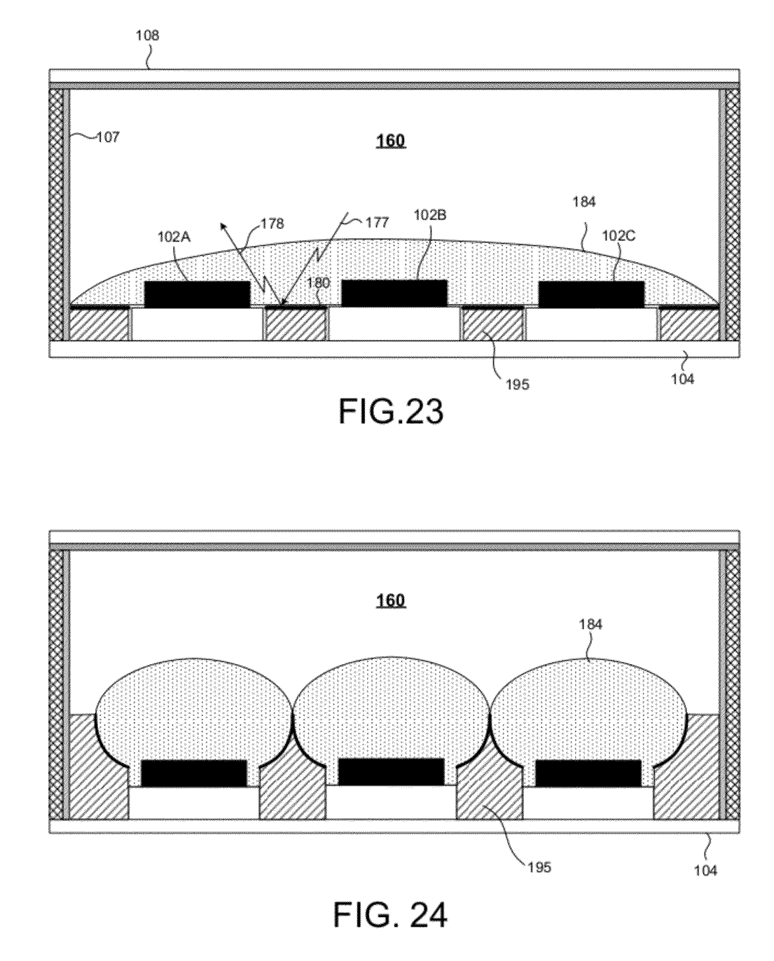

FIG. 23 is illustrative of a cross-sectional, side view of an LED based illumination module 100 in one embodiment. As illustrated, LED based illumination module 100 includes a plurality of LEDs 102A-102C, a sidewall 107, an output window 108, an interspatial reflector 195 and overmolded lens 184. As discussed with respect to FIG. 6, sidewall 107 includes a wavelength converting material (e.g., a red-emitting phosphor material) and output window 108 includes a wavelength converting material with a different color conversion property than the wavelength converting material included in sidewall 107 (e.g., a yellow-emitting phosphor material). Color conversion cavity 160 is bounded by sidewall 107, output window 108, and interspatial reflector 195 of LED based illumination module 100. In some embodiments, interspatial reflector 195 includes a wavelength converting material 180. In these embodiments, for example a back reflected photon 177 incident to a surface of interspatial reflector 195 is color converted and directed toward output window 108 as photon 178.

Interspatial reflector 195 is configured so that back reflected light (light that is reflected back from color conversion cavity 160 toward mounting board 104 and LEDs 102) is redirected back into color conversion cavity 160. By including an interspatial reflector 195 between LEDs 102, light that might otherwise be absorbed by the mounting board is recycled. Thus, the light extraction efficiency of color conversion cavity 160 is improved.

FIG. 24 is illustrative of another embodiment of LED based illumination module 100. The embodiment depicted in FIG. 24 is analogous to that depicted in FIG. 23, except that interspatial reflector 195 includes shaped surfaces to promote light extraction from LEDs 102. In some embodiments, interspatial reflector 195 includes a parabolic shaped surface to collimate light emitted from each LED 102. In some other embodiments, interspatial reflector 195 includes an elliptically shaped surface to focus light emitted from each LED. Other profiles may be contemplated (e.g., spherical, aspheric, etc.).

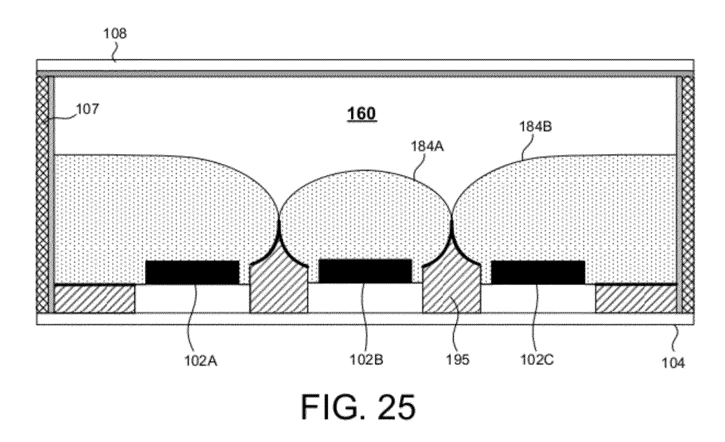

FIG. 25 is illustrative of another embodiment of LED based illumination module 100. The embodiment depicted in FIG. 25 is analogous to that depicted in FIGS. 23 and 24, except that overmolded lens 184 is shaped differently over different LEDs 102. For example, as illustrated in FIG. 25, overmolded lens 184A over LED 102B located in the center of color conversion cavity 160 is shaped to promote extraction of light toward output window 108. However, overmolded lens 184B over LED 102C located at the periphery of color conversion cavity 160 is shaped to promote extraction of light toward sidewall 107. In this manner, different shaped overmolded lenses are utilized to direct light to different surfaces to promote efficient color conversion.

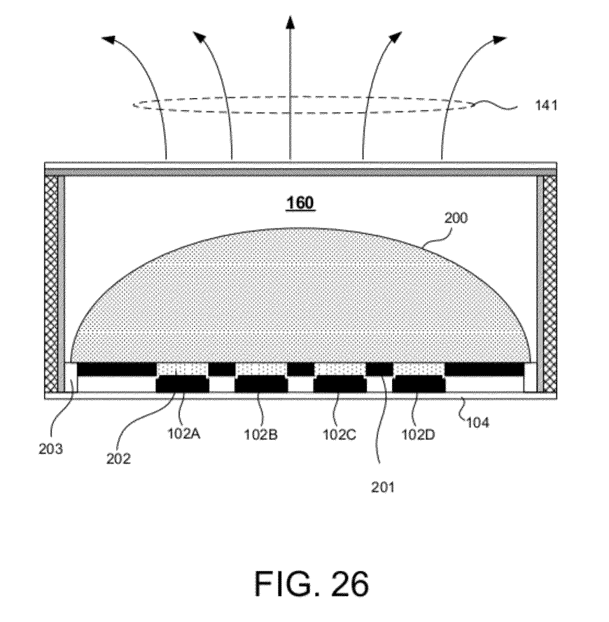

FIG. 26 is illustrative of another exemplary embodiment of an LED based illumination module 100. In one aspect, patterned reflective layer 201 is attached to lens element 200 and is located between lens element 200 and LEDs 102. Lens element 200 is mechanically and optically coupled to a plurality of LEDs (e.g., LEDs 102A-D) by an optically transparent bonding material 202. In some embodiments, a mounting feature 203 is included to position lens element 200 above LEDs 102. For example, mounting feature 203 may include a mechanical reference surface to establish the distance between lens element 200 and the top surfaces of LEDs 102.

In another aspect, reflective mask cover plate 173 is attached to lens element 200 and is located between lens element 200 and LEDs 102. In some embodiments, reflective mask cover plate 173 includes lens element 200 attached to or molded into a surface of transmissive layer 174. The lens structure may improve light extraction by directing light emitted from LEDs 102 toward output window 108. For example, reflective mask cover plate 173 may include an array of conical shaped, pyramid shaped, or lens shaped structures.

In some embodiments, lens element 200 is constructed from a plastic material by an injection molding process to provide a low-cost, high volume advantage. However, other materials (e.g., glass, alumina, ceramic, etc.) and other manufacturing processes (e.g., machining, grinding, casting, etc.) may be employed. In some embodiments, at least one wavelength converting material may be included in the mix material and molded with lens element 200.

Bonding material 202 is selected to provide for efficient optical transmission to lens element 200. In some embodiments, the refractive index of bonding material 202 should closely match the refractive index of lens element 200 to minimize Fresnel losses at the interface between bonding material 202 and the lens element 200. Bonding material 202 should be a compliant material that is able to conform to geometric changes in LED based illumination module 100. For example, during operation, LED based illumination module 100 may be subjected to a wide range of environmental temperatures and operating cycles. Due to differences in geometry and thermal coefficients of expansion of various elements of LED based illumination module 100, the mechanical interfaces between bonding material 202 and LEDs 102 and between bonding material 202 and lens element 200 are subject to relative movement. Bonding material 202 must conform to these movements without failing or generating excessive stress on either LEDs 102 or lens element 200. In one embodiment, bonding material 202 is a silicone based material that is index matched to the material of lens element 200. In some other embodiments, bonding material 202 includes a compliant material that is bonded to the LED by a thin layer of optical adhesive. In some embodiments, the layer of optical adhesive is thin to minimize beam spreading from the LED light source.

In some embodiments, patterned reflective layer 201 is attached to lens element 200. In some embodiments, patterned reflective layer 201 is made with a highly thermally conductive material, such as an aluminum based material that is processed to make the material highly reflective and durable. By way of example, a material referred to as Miro®, manufactured by Alanod, a German company, may be used. The material may be punched to provide openings in patterned reflective layer 201 for light to pass. In some other embodiments, patterned reflective layer 201 includes a suitably reflective material or combination of materials (e.g., silver, aluminum) plated on lens element 200. In some other embodiments, patterned reflective layer 201 includes a highly reflective thin film material, such as Vikuiti™ ESR, as sold by 3M (USA), Lumirror™ E60L manufactured by Toray (Japan), or microcrystalline polyethylene terephthalate (MCPET) attached to lens element 200. In some other embodiments, patterned reflective layer 201 includes reflective coatings applied to lens element 200. Such coatings may include titanium dioxide (TiO2), zinc oxide (ZnO), and barium sulfate (BaSO4) particles patterned onto lens element 200. The pattern of patterned reflective layer 201 is configured such that light emitted from LEDs 102 passes through to lens element 200 with a minimum of light blockage. However, patterned reflective layer 201 is configured so that back reflected light (e.g., light that is reflected back from color conversion cavity 160 toward mounting board 104 and LEDs 102) is redirected back into color conversion cavity 160. By including a patterned reflective layer 201 above the mounting board 104, light that might otherwise be absorbed by the mounting board is recycled. Thus, the light extraction efficiency of color conversion cavity 160 is improved.

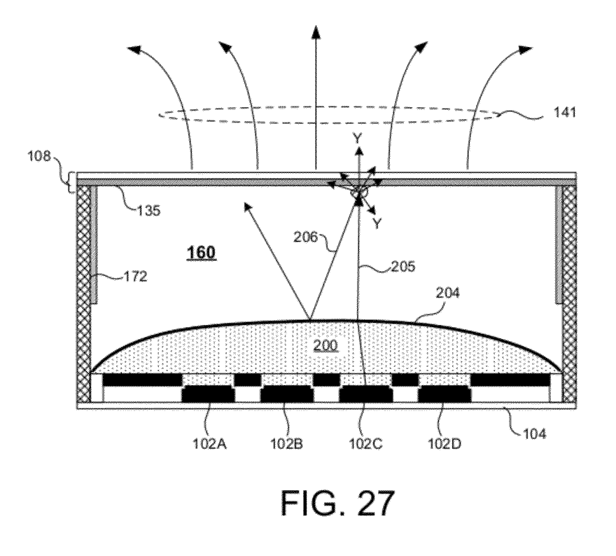

FIG. 27 is illustrative of another exemplary embodiment of an LED based illumination module 100. The embodiment of FIG. 27 includes similar features as discussed with reference to FIG. 26. In one aspect of the illustrated embodiment, the outward facing surface of lens element 200 includes a dichroic coating that passes light emitted from LEDs 102, but reflects light emitted from a wavelength converting material included in color conversion cavity 160. In the depicted embodiment, output window 108 includes a wavelength converting material 135 (e.g., a coating of yellow emitting phosphor material). In the depicted embodiment, a blue photon 205 is emitted from LED 102C. The blue photon passes through dichroic coating 204 and is absorbed by a phosphor particle of wavelength converting material 135. The phosphor particle absorbs blue photon 205 and emits yellow light generally in a Lambertian emission pattern. Some of the emitted yellow light is transmitted forward through output window 108 and is part of combined light 141. However, a portion of the emitted yellow light is emitted toward lens element 200. For example, yellow photon 206 is emitted from a phosphor particle and is reflected from the surface of lens element 200 by dichroic coating 204. In this manner, back reflected light (e.g., yellow photon 206) is redirected toward output window 108 and out of LED based illumination module 100 rather than being reabsorbed by an element module 100 (e.g., LEDs 102). Thus, the extraction efficiency of LED based illumination module 100 is improved.

Although, FIG. 27 illustrates a single dichroic coating 204 located on the outward facing surface of lens element 200, other configurations may be contemplated. For example dichroic coating 204 may be located on some portions of lens element 200 and not on others. In another example, portions of lens element 200 may be coated with different dichroic coatings. For example, portions of lens element 200 located close to color converting layer 135 that includes a yellow emitting phosphor may be coated with a dichroic coating that reflects yellow light. However, portions of lens element 200 located close to color converting layer 172 that includes a red emitting phosphor may be coated with a different dichroic coating that reflects red light. In another example, lens element 200 may include multiple surfaces. These surfaces may be coated with different dichroic coatings.

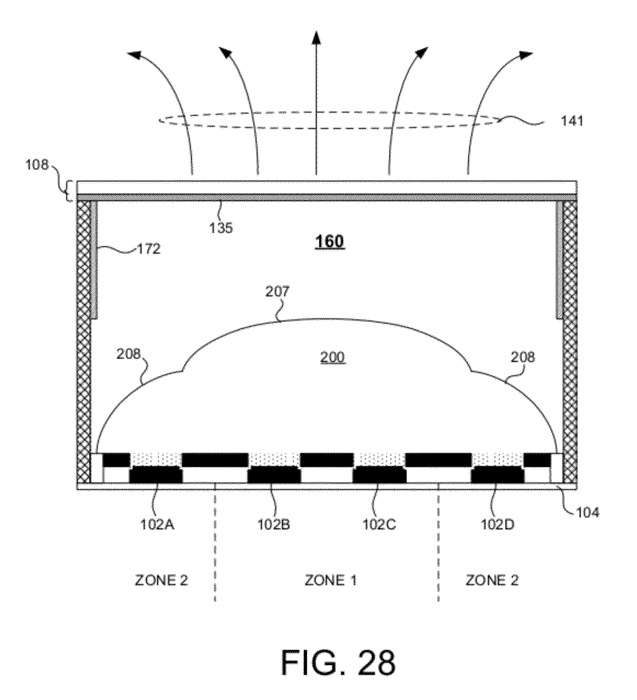

FIG. 28 is illustrative of another exemplary embodiment of an LED based illumination module 100. In one aspect of the illustrated embodiment, lens element 200 includes two different surface profiles joined on the outward facing surface of lens element 200. As illustrated, a portion of lens element 200 includes surface profile 207. Another portion of lens element 200 includes surface profile 208 that is different than surface profile 207. In other words, a mathematical function that describes surface profiles 207 and 208 may be continuous (e.g., surface profiles 207 and 208 are connected), but non-smooth (e.g., a spatial derivative of the function evaluated at a point of intersection of the two profiles is discontinuous). Different profiles may be contemplated for surface profiles 207 and 208 (e.g., spherical, aspherical, elliptical, parabolic, Bezier, etc.).

In one embodiment, surface profile 207 may have a parabolic shape. This shape generally promotes light extraction from LEDs 102 physically located within a first zone of LEDs 102 (e.g., zone 1) and generally directs light from these LEDs toward output window 108. Surface profile 208 may also have a parabolic shape that promotes light extraction from LEDs 102 located within a different zone of LEDs 102 (e.g., zone 2) and generally directs light toward sidewall 107. In this manner, the different surface profiles of lens element 200 are located over different groups of LEDs to direct light to different color converting surfaces (e.g., color converting layer 172 and color converting layer 135). Furthermore, LEDs located in different zones may emit different colored light that more closely matches the absorbtion spectra of the different wavelength converting materials in different locations.

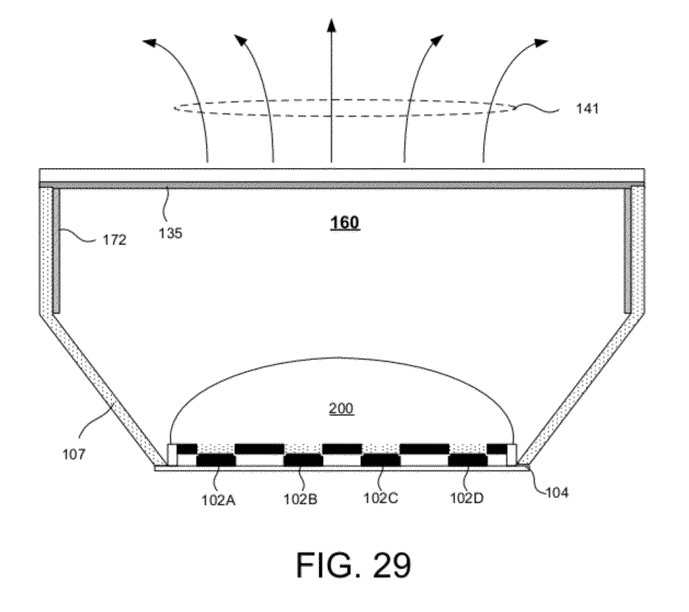

FIG. 29 is illustrative of another exemplary embodiment of an LED based illumination module 100. In one aspect of the illustrated embodiment, a portion of sidewall 107 is oriented at an oblique angle with respect to mounting board 104. More specifically, the portion of sidewall 107 closest to mounting board 104 tapers outward from mounting board 104. In this manner, light emitted from lens element 200 at large angles is reflected upward by sidewall 107 toward output window 108. In this manner, light extraction from LED based illumination module 100 is promoted. In the depicted embodiment, a portion of sidewall 107 closest to LEDs 102 is not coated with a wavelength converting material and is, e.g., specularly reflective. However, a portion of sidewall 107 located distant from LEDs 102 is coated with a wavelength converting layer 172. In this manner, light transmitted from lens element 200 at large angles is reflected outward without color conversion. However, by locating color converting layer 172 further from LEDs 102, the probablility that color converted light emitted from color converting layer 172 is reabsorbed by any of LEDs 102 is reduced. Thus, the efficiency of color conversion cavity 160 is increased.

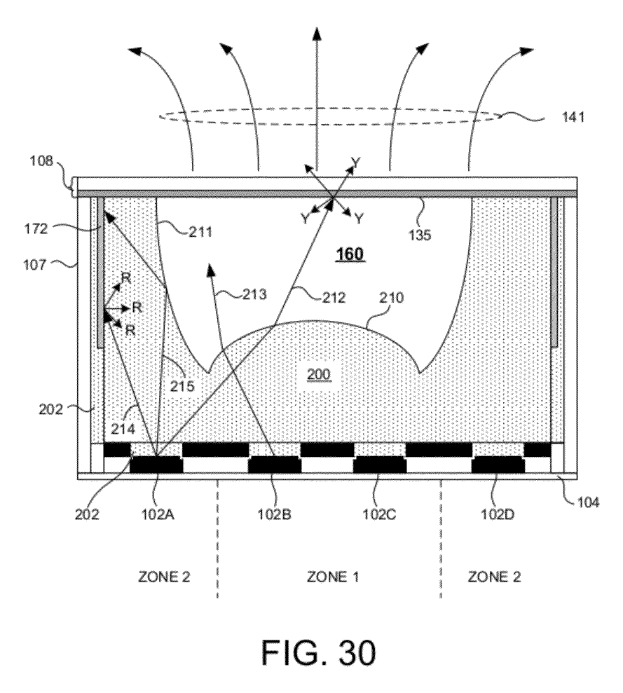

FIG. 30 is illustrative of another exemplary embodiment of an LED based illumination module 100. In one aspect of the illustrated embodiment, lens element 200 is physically and optically coupled to LEDs 102 and is optically coupled to sidewall 107 of color conversion cavity 160. In the illustrated embodiment, lens element 200 is coupled to LEDs 102 and sidewall 107 by bonding material 202 as discussed herein. In the illustrated embodiment, color converting layer 172 is attached to lens element 200 and lens element 200 with color converting layer 172 is inserted into color conversion cavity 160 and is attached to color conversion cavity 160 by bonding material 202. In some other embodiments, color converting layer 172 is attached to sidewall 107 and lens element 200 is inserted into color conversion cavity 160 and is attached by bonding material 202. In some other embodiments, lens element 200 is inserted into color conversion cavity 160 and is attached to LEDs 102 by bonding material 202, but is not physically attached to sidewall 107 by bonding material 202. In some of these embodiments, lens element 200 may be closely fitted to sidewall 107. In some of these embodiments, a gap exists between lens element 200 and sidewall 107.

In the illustrated embodiment, lens element 200 includes two different surfaces each characterized by a different surface profile. The two surfaces are joined on the outward facing surface of lens element 200. As illustrated, a portion of lens element 200 includes surface profile 210. Another portion of lens element 200 includes surface profile 211 that is different than surface profile 210.

As illustrated in FIG. 30, surface profile 210 is located over LEDs (e.g., LEDs 102B-C) grouped together based on their physical location within LED based illumination module 100 (e.g., within zone 1). Surface profile 210 is shaped to promote extraction of light from LEDs 102, and in particular, LEDs 102B and 102C. For example, photon 213 emitted from LED 102B is directed toward output window 108.

In some embodiments, surface profile 210 includes a dichroic coating that passes light emitted from LEDs 102, but reflects light emitted from a wavelength converting material included in color conversion cavity 160. In the depicted embodiment, output window 108 includes a wavelength converting material 135 (e.g., a coating of yellow emitting phosphor material). In the depicted embodiment, a blue photon 212 is emitted from LED 102A. The blue photon passes through a dichroic coating applied to surface 210 and is absorbed by a phosphor particle of wavelength converting material 135. The phosphor particle absorbs blue photon 212 and emits yellow light generally in a Lambertian emission pattern. Some of the emitted yellow light is transmitted forward through output window 108 and becomes part of combined light 141. However, a portion of the emitted yellow light is emitted toward lens element 200. However, yellow photons are reflected from the surface 210 of lens element 200 by the dichroic coating. In this manner, back reflected light is redirected toward output window 108 and out of LED based illumination module 100 rather than being reabsorbed by an element module 100 (e.g., LEDs 102).

As illustrated in FIG. 30, surface profile 211 is located over LEDs (e.g., LEDs 102A and 102D) grouped together based on their physical location within LED based illumination module 100 (e.g., within zone 2). Surface profile 211 is shaped to direct light from LEDs 102, and in particular LEDs 102A and 102D, toward sidewall 107 where the emitted light may be color converted by wavelength converting material located within color conversion layer 172. For example, photon 214 emitted from LED 102A passes directly to color converting layer 172. If surface 210 extended over LED 102A, photon 214 might be directed toward output window 108 by refraction rather than interacting with color converting layer 172.

In some embodiments, surface profile 211 includes a dichroic coating that passes light emitted from color converting layer 172 (e.g., red light), but reflects light emitted from color converting layer 135 (e.g., yellow light) and reflects light emitted from LEDs 102. In this manner, some light emitted from LEDs 102, in particular light emitted from LEDs 102A and 102D is channeled toward color converting layer 172, thus promoting color conversion. For example, as illustrated in FIG. 30, photon 215 emitted from LED 102A passes through lens element 200, and reflects from surface 211 by action of the dichroic coating. The reflected photon then interacts with color converting layer 172. Emission from color converting layer 172 passes through surface profile 211, thus promoting light mixing and extraction from LED based illumination module 100. Furthermore, emission from color converting layer 135 is reflected from surface 211. This reduces the probability that color converted light from color converting layer 135 is reabsorbed by elements of LED based illumination module 100 before extraction.

In some embodiments, surface profile 211 includes a reflective coating. In this manner, some light emitted from LEDs 102, in particular light emitted from LEDs 102A and 102D is channeled toward color converting layer 172, thus promoting color conversion. Furthermore, emission from color converting layer 135 is reflected from surface 211 rather than entering lens element 200.

In some embodiments, surfaces of lens element 200 include anti-reflective (AR) coatings. With AR coatings reflective losses may be reduced. For example, reflective losses of untreated optical surfaces (e.g., 4% loss) may be reduced by the addition of an AR coating (e.g., 0.5% loss).

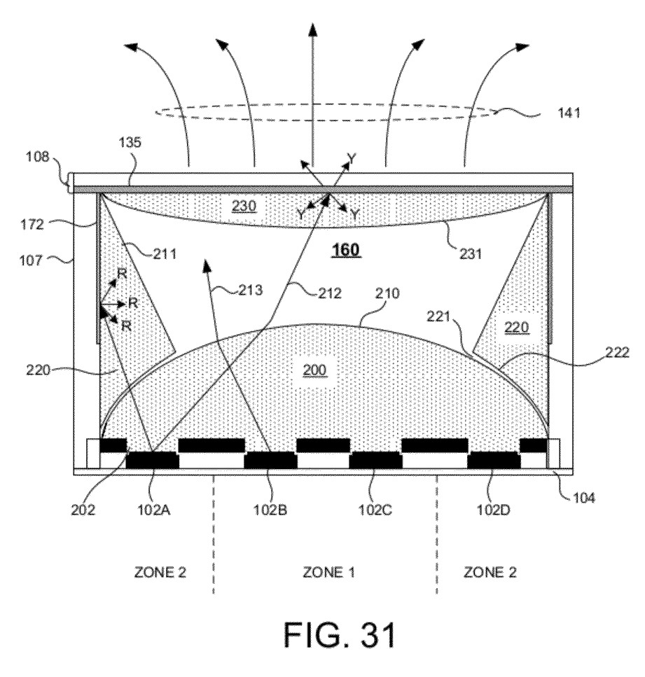

FIG. 31 is illustrative of another exemplary embodiment of an LED based illumination module 100. In one aspect of the illustrated embodiment, lens element 200 is physically and optically coupled to LEDs 102, lens element 220 is physically and optically coupled to sidewall 107, and lens element 230 is physically and optically coupled to output window 108 of color conversion cavity 160. In the illustrated embodiment, lens element 200 is coupled to LEDs 102, lens element 220 is coupled to sidewall 107, and lens element 230 is coupled to output window 108 by any of a bonding material 202 and a mechanical fit (e.g., interference fit, weldement, attachment feature, etc.).

In the illustrated embodiment, color converting layer 172 is attached to sidewall 107. However, in some other embodiments, color converting layer 172 may be attached to lens element 220 and fit into color conversion cavity 160. In this manner, color converting layer 172 may be adjusted (e.g., by abrasion, laser ablation, etc.) to tune the color conversion properties of layer 172 before final assembly of LED based illumination module 100. As illustrated there is no air gap between color converting layer 172 and sidewall 107. However, in some other embodiments an air gap may be present between color converting layer 172 and sidewall 107.

In the illustrated embodiment, an air gap 221 separates lens elements 200 and 220. In some other embodiments, air gap 221 may be filled with a solid material. In some other embodiments, lens elements 200 and 220 may not be separated by an air gap 221.

In the illustrated embodiment, lens element 200 includes surface profile 210 and lens element 220 includes surface profiles 211 and 222. As illustrated in FIG. 21, surface profile 210 is located over LEDs 102.

Surface profile 210 is shaped to promote extraction of light from LEDs 102. For example, photon 213 emitted from LED 102B is directed toward output window 108. In some embodiments, the surface of lens element 200 may be roughened to promote extraction from LEDs 102. In some embodiments, as discussed with reference to FIG. 20, surface profile 210 includes a dichroic coating that passes light emitted from LEDs 102, but reflects light emitted from a wavelength converting material included in color conversion cavity 160.

As illustrated in FIG. 31, surface profile 211 is located over LEDs (e.g., LEDs 102A and 102D) grouped together based on their physical location within LED based illumination module 100 (e.g., within zone 2). Surface profile 211 is shaped to direct light from LEDs 102, and in particular LEDs 102A and 102D, toward sidewall 107 where the emitted light may be color converted by wavelength converting material located within color conversion layer 172. In some embodiments, surface profile 211 includes a dichroic coating that passes light emitted from color converting layer 172 (e.g., red light), but reflects light emitted from color converting layer 135 (e.g., yellow light) and reflects light emitted from LEDs 102. In this manner, some light emitted from LEDs 102, in particular light emitted from LEDs 102A and 102D is channeled toward color converting layer 172, thus promoting color conversion.

Light emitted from color converting layer 172 is generally emitted in a Lambertian pattern. By separating lens element 220 from lens element 210 by air gap 221, some amount of light emitted from color converting layer 172 toward LEDs 102 reflects off of surface 222 rather than being transmitted through to LEDs 102. This reflected light may then emerge from lens element 220 through surface 211 rather than being reabsorbed by LEDs 102. Thus, light extraction efficiency is improved.

Lens element 230 includes a surface profile 231. Light emitted from color converting layer 135 is generally emitted in a Lambertian pattern. Some of the light emitted from color converting layer 135 toward LEDs 102 reflects off of surface 231 rather than being transmitted through to LEDs 102. This reflected light may then emerge from output window 108 rather than being reabsorbed by LEDs 102. Thus, light extraction efficiency is improved. In the illustrated embodiment, lens 230 has a convex shape. The shape of surface profile 231 is selected to direct light forward through output window 108.

In some embodiments, surfaces of any of lens elements 200, 220, and 230 include anti-reflective (AR) coatings. With AR coatings reflective losses may be reduced. For example, reflective losses of untreated optical surfaces (e.g., 4% loss) may be reduced by the addition of an AR coating (e.g., 0.5% loss).

In some embodiments, any of reflective mask cover plate 173 (e.g., reflective structure 190) and interspatial reflector 195 may be constructed from or include a PTFE material. In some examples a component may include a PTFE layer backed by a reflective layer such as a polished metallic layer. The PTFE material may be formed from sintered PTFE particles. In some embodiments, portions of any of the interior facing surfaces of color conversion cavity 160 may be constructed from a PTFE material. In some embodiments, the PTFE material may be coated with a wavelength converting material. In other embodiments, a wavelength converting material may be mixed with the PTFE material.

In other embodiments, any of reflective mask cover plate 173 (e.g., reflective structure 190) and interspatial reflector 195 may be constructed from or include a reflective, ceramic material, such as ceramic material produced by CerFlex International (The Netherlands). In some embodiments, portions of any of the interior facing surfaces of color conversion cavity 160 may be constructed from a ceramic material. In some embodiments, the ceramic material may be coated with a wavelength converting material.

In other embodiments, any of reflective mask cover plate 173 (e.g., reflective structure 190) and interspatial reflector 195 may be constructed from or include a reflective, metallic material, such as aluminum or Miro® produced by Alanod (Germany). In some embodiments, portions of any of the interior facing surfaces of color conversion cavity 160 may be constructed from a reflective, metallic material. In some embodiments, the reflective, metallic material may be coated with a wavelength converting material.

In other embodiments, any of reflective mask cover plate 173 (e.g., reflective structure 190) and interspatial reflector 195 may be constructed from or include a reflective, plastic material, such as Vikuiti™ ESR, as sold by 3M (USA), Lumirror™ E60L manufactured by Toray (Japan), or microcrystalline polyethylene terephthalate (MCPET) such as that manufactured by Furukawa Electric Co. Ltd. (Japan). In some embodiments, portions of any of the interior facing surfaces of color conversion cavity 160 may be constructed from a reflective, plastic material. In some embodiments, the reflective, plastic material may be coated with a wavelength converting material.

Cavity 160 may be filled with a non-solid material, such as air or an inert gas, so that the LEDs 102 emits light into the non-solid material. By way of example, the cavity may be hermetically sealed and Argon gas used to fill the cavity. Alternatively, Nitrogen may be used. In other embodiments, cavity 160 may be filled with a solid encapsulate material. By way of example, silicone may be used to fill the cavity. In some other embodiments, color conversion cavity 160 may be filled with a fluid to promote heat extraction from LEDs 102. In some embodiments, wavelength converting material may be included in the fluid to achieve color conversion throughout the volume of color conversion cavity 160.

Although certain specific embodiments are described above for instructional purposes, the teachings of this patent document have general applicability and are not limited to the specific embodiments described above. For example, although LED based illumination module 100 is depicted as emitting from the top of the module (i.e., the side opposite the LED mounting board 104), in some other embodiments, LED based illumination module 100 may emit light from the side of the module (i.e., a side adjacent to the LED mounting board 104). In another example, any component of color conversion cavity 160 may be patterned with phosphor. Both the pattern itself and the phosphor composition may vary. In one embodiment, the illumination device may include different types of phosphors that are located at different areas of a light mixing cavity 160. For example, a red phosphor may be located on either or both of the insert 107 and the bottom reflector insert 106 and yellow and green phosphors may be located on the top or bottom surfaces of the window 108 or embedded within the window 108. In one embodiment, different types of phosphors, e.g., red and green, may be located on different areas on the sidewalls 107. For example, one type of phosphor may be patterned on the sidewall insert 107 at a first area, e.g., in stripes, spots, or other patterns, while another type of phosphor is located on a different second area of the insert 107. If desired, additional phosphors may be used and located in different areas in the cavity 160. Additionally, if desired, only a single type of wavelength converting material may be used and patterned in the cavity 160, e.g., on the sidewalls. In another example, cavity body 105 is used to clamp mounting board 104 directly to mounting base 101 without the use of mounting board retaining ring 103. In other examples mounting base 101 and heat sink 120 may be a single component. In another example, LED based illumination module 100 is depicted in FIGS. 1-3 as a part of a luminaire 150. As illustrated in FIG. 3, LED based illumination module 100 may be a part of a replacement lamp or retrofit lamp. But, in another embodiment, LED based illumination module 100 may be shaped as a replacement lamp or retrofit lamp and be considered as such. In another example, LED locations and lens elements 184, 200, 220, and 230 are illustrated as symmetrical in shape. But, in other embodiments, any of the LED locations and any of lens elements 184, 200, 220, and 230 may by asymmetrical in shape. Accordingly, various modifications, adaptations, and combinations of various features of the described embodiments can be practiced without departing from the scope of the invention as set forth in the claims.

What is claimed is:

1. An LED based illumination device, comprising:
a plurality of LEDs, the plurality of LEDs operable to emit light with a first color;
a lens element disposed above and physically coupled to the plurality of LEDs, the lens element including a dichroic filter; and
a color conversion cavity enveloping the lens element, the color conversion cavity including a first wavelength converting material operable to absorb light with the first color and emit light with a second color, wherein the dichroic filter transmits light with the first color and reflects light with the second color.

2. The LED based illumination device of claim 1, the color conversion cavity including an output window and at least one sidewall.

3. The LED based illumination device of claim 2, wherein the output window includes the first wavelength converting material and the at least one sidewall includes a second wavelength converting material.

4. An LED based illumination device, comprising:
a plurality of LEDs; and
a lens element disposed above and physically coupled to the plurality of LEDs, the lens element including a first surface profile disposed above a first group of the plurality of LEDs and a second surface profile disposed above a second group of the plurality of LEDs, wherein the first surface profile and the second surface profile are joined at an output surface of the lens element.

5. The LED based illumination device of claim 4, further comprising:
a color conversion cavity enveloping the lens element, the color conversion cavity including an output window and at least one sidewall.

6. The LED based illumination device of claim 5, wherein the first group of the plurality of LEDs are located closer to the at least one sidewall than the second group of the plurality of LEDs.

7. The LED based illumination device of claim 6, wherein a shape of the first surface profile and a shape of the second surface profile is any of an elliptical shape, a parabolic shape, and a spherical shape.

8. An LED based illumination device, comprising:
a plurality of LEDs mounted in a plane;
a lens element disposed above and physically coupled to the plurality of LEDs; and
a color conversion cavity enveloping the lens element, the color conversion cavity including a sidewall, wherein the lens element is physically coupled to the sidewall.

9. The LED based illumination device of claim 8, wherein the color conversion cavity includes a first wavelength converting material operable to absorb light emitted from the plurality of LEDs and emit a different colored light.

10. The LED based illumination device of claim 9, wherein the lens element includes a first surface profile and a second surface profile.

11. The LED based illumination device of claim 8, wherein the color conversion cavity includes a first wavelength converting material operable to absorb light emitted from the plurality of LEDs and emit a first color converted light, wherein the lens element includes a first surface with a first surface profile, and wherein at least a portion of the first surface includes a first dichroic filter that passes light emitted from the plurality of LEDs and reflects the first color converted light.

12. The LED based illumination device of claim 11, wherein the color conversion cavity includes a second wavelength converting material operable to absorb light emitted from the plurality of LEDs and emit a second color converted light, wherein the lens element includes a second surface with a second surface profile, and wherein at least a portion of the second surface includes a second dichroic filter that passes the second color converted light and reflects the first color converted light.
